(19) United States
(12) Patent Application Publication
(10) Pub. No.: US 2026/0239121 A1
(43) Pub. Date: Aug. 13, 2026

(54) DEVICES AND METHODS IN A MULTI-RADIO DUAL CONNECTIVITY (MR-DC) ENVIRONMENT

(71) Applicant: Lenovo (Beijing) Limited, Beijing (CN)

(72) Inventors: Shuigen Yang, Shanghai (CN); Lianhai Wu, Beijing (CN); Congchi Zhang, Shanghai (CN); Mingzeng Dai, Shanghai (CN); Le Yan, Shanghai (CN)

(73) Assignee: Lenovo (Beijing) Limited, Beijing (CN)

(21) Appl. No.: 19/152,673

(22) PCT Filed: May 11, 2023
(86) PCT No.: PCT/CN2023/093680

§ 371 Date: Jul. 31, 2025

(51) Int. Cl. H04W 36/00; H04W 36/36

(52) U.S. Cl. CPC H04W 36/00698; H04W 36/0072; H04W 36/362

(57) ABSTRACT

Embodiments of the present disclosure relate to network devices, a terminal device, and methods performed by the network devices and/or the terminal device. In an aspect, a first network device determines a conditional handover (CHO)-only configuration, wherein the CHO-only configuration does not support a terminal device to perform a conditional primary secondary cell addition or change (CPAC) in a multi-radio dual connectivity (MR-DC) environment. The first network device transmits, to the terminal device, the CHO-only configuration for deployment by the terminal device in the event that a CPAC execution condition in the MR-DC environment is not fulfilled by the terminal device. In this way, the communication reliability and efficiency may be improved.

### FIELD

Embodiments of the present disclosure generally relate to the field of communication, and in particular to network devices, a terminal device, methods performed by the network devices and/or the terminal device, and non-transitory computer readable media for communications in conditional handover (CHO) procedures.

### BACKGROUND

When a user equipment (UE) moves from one cell to another cell, at some point a serving cell change needs to be performed. In the legacy, the serving cell change may be done by explicit radio resource control (RRC) reconfiguration signaling to trigger the synchronization of target cell based on layer 3 (L3) measurements report, which might lead to longer latency, larger overhead, and longer interruption time than beam level mobility. Therefore, CHO is introduced to improve the handover performance. The CHO is defined as a handover that is executed by the UE when one or more handover execution conditions are fulfilled. The UE starts evaluating the execution condition(s) upon receiving the CHO configuration and stops evaluating the execution condition(s) once a handover is executed.

As the demand for mobile broadband access continues to increase, there exists a need for further improvements in the new radio (NR) and the long term evolution (LTE) technology. Preferably, these improvements should be applicable to other multi-access technologies and the telecommunication standards that employ these technologies. In particular, enhancements on CHO procedures in multi-radio dual connectivity (MR-DC) scenarios are still needed.

### SUMMARY

In general, embodiments of the present disclosure provide network devices, a terminal device, methods, and non-transitory computer readable media for communications in CHO.

In a first aspect, there is provided a first network device. The first network device comprises a processor and a transceiver coupled to the processor. The processor is configured to: determine a conditional handover (CHO)-only configuration, wherein the CHO-only configuration does not support a terminal device to perform a conditional primary secondary cell addition or change (CPAC) in a multi-radio dual connectivity (MR-DC) environment; and transmit, via the transceiver to the terminal device, the CHO-only configuration for deployment by the terminal device in the event that a CPAC execution condition in the MR-DC environment is not fulfilled by the terminal device.

In a second aspect, there is provided a terminal device. The terminal device comprises a processor and a transceiver coupled to the processor. The processor is configured to: receive, via the transceiver from a first network device, a conditional handover (CHO)-only configuration, wherein the CHO-only configuration does not support the terminal device to perform a conditional primary secondary cell addition or change (CPAC) in a multi-radio dual connectivity (MR-DC) environment; and deploy the CHO-only configuration in the event that a CPAC execution condition is not fulfilled.

In a third aspect, there is provided a second network device. The second network device comprises a processor and a transceiver coupled to the processor. The processor is configured to: determine a cell configuration for at least one candidate target cell associated with the second network device, wherein the cell configuration is associated with a conditional handover (CHO)-only configuration, wherein the CHO-only configuration does not support a terminal device to perform a conditional primary secondary cell addition or change (CPAC) in a multi-radio dual connectivity (MR-DC) environment; and transmit, via the transceiver to a first network device, the cell configuration.

In a fourth aspect, there is provided a method performed by a first network device. The method comprises: determining a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to the terminal device, the CHO-only configuration for deployment by the terminal device in the event that a CPAC execution condition in the MR-DC environment is not fulfilled by the terminal device.

In a fifth aspect, there is provided a method performed by a terminal device. The method comprises: receiving, from a first network device, a conditional handover (CHO)-only configuration, wherein the CHO-only configuration does not support the terminal device to perform a conditional primary secondary cell addition or change (CPAC) in a multi-radio dual connectivity (MR-DC) environment; and deploying the CHO-only configuration in the event that a CPAC execution condition is not fulfilled.

In a sixth aspect, there is provided a method performed by a second network device. The method comprises: determining a cell configuration for at least one candidate target cell associated with the second network device, wherein the cell configuration is associated with a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to a first network device, the cell configuration.

In a seventh aspect, there is provided a computer readable medium having instructions stored thereon. The instructions, when executed on at least one processor, cause the at least one processor to perform the method according to any of the fourth to sixth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates a schematic diagram of a communication environment in which some embodiments of the present disclosure can be implemented;

FIGS. 1B and 1C illustrate an example signaling chart illustrating a conditional handover with secondary node procedure in a related solution;

FIG. 2 illustrates an example signaling chart illustrating communication process in accordance with some example embodiments of the present disclosure;

FIG. 3A illustrates a schematic diagram illustrating an example process of for a successful handover using CHO-only configuration via RRC configuration according to embodiments of the present disclosure;

FIG. 3B illustrates a schematic diagram illustrating an example process of for successful handover using CHO-only configuration via a medium access control (MAC) control element (CE) according to embodiments of the present disclosure;

FIG. 3C illustrates a schematic diagram illustrating an example process of a fast recovery according to embodiments of the present disclosure;

FIG. 4 illustrates a flowchart of an example method of communication implemented at a first network device in accordance with some embodiments of the present disclosure;

FIG. 5 illustrates a flowchart of an example method of communication implemented at a terminal device in accordance with some embodiments of the present disclosure;

FIG. 6 illustrates a flowchart of an example method of communication implemented at a second network device in accordance with some embodiments of the present disclosure; and

FIG. 7 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a remote radio unit (RRU), a radio header (RHI), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an internet of things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As mentioned above, when the UE moves from one cell to another cell, at some point a serving cell change needs to be performed. In the legacy, the serving cell change is done by explicit RRC reconfiguration signaling to trigger the synchronization of target cell based on L3 measurements report. It leads to longer latency, larger overhead, and longer interruption time than beam level mobility. Therefore, CHO is introduced to improve the handover performance. The CHO is defined as a handover that is executed by the UE when one or more handover execution conditions are fulfilled. The UE starts evaluating the execution condition(s) upon receiving the CHO configuration and stops evaluating the execution condition(s) once a handover is executed.

In a MR-DC scenario, the UE may simultaneously connect with two radio access nodes. Among the two radio access nodes establishing a connection with the UE, only one radio access node (hereinafter referred to as a “master node (MN)”) establishes an RRC connection with the UE and provides the control plane connection to the core network. A group of serving cells associated with the MN may be referred to as a master cell group (MCG). The MCG may include a primary cell (PCell) and optionally one or more secondary cells (SCells). Another radio access node (hereinafter referred to as “secondary node (SN)”) provides additional radio resources to the UE with no control plane connection to the core network. A group of serving cells associated with the SN may be referred to as a secondary cell group (SCG). The SCG may include a primary secondary cell (PSCell) and optionally one or more secondary cells (SCells).

In the case of such as UE mobility or changes of channel quality, the UE may perform the CHO from the source MN (S-MN) towards potential target MNs (T-MNs), and may perform conditional PSCell addition (CPA) or conditional PSCell change (CPC) from the source SN (S-SN) towards potential target SNs (T-SNs). The CPA may refer to a PSCell addition that is executed by the UE when corresponding execution condition(s) is fulfilled. The CPC may refer to a PSCell change that is executed by the UE when corresponding execution condition(s) is fulfilled. In short, such scenario may be referred to as “CHO with candidate SCGs”. For the CHO with candidate SCGs, there may be multiple potential target MNs as well as multiple potential target SNs.

In the context of the present disclosure, the term “CHO with candidate SCGs” may be interchangeably used with “CHO with CPAC” and “CPAC-associated CHO”. In the context of the present disclosure, the term “CPAC” may be interchangeably used with “CPA or CPC” and “CPA/CPC”.

In the context of the present disclosure, the term “potential target MN” may be interchangeably used with “target MNs”, “candidate target MNs”, “candidate MCGs”, “candidate target MCGs”, “candidate MNs”, “target network devices”, “candidate target network devices” and “candidate network devices”. In the context of the present disclosure, the term “candidate target cells” may be interchangeably used with “target cells”, “candidate cells”, “target PCells”, “candidate target PCells”, and “target PCells”.

In the context of the present disclosure, the term “potential target SN” may be interchangeably used with “target SNs”, “candidate target SNs”, “candidate SCGs”, “candidate target SCGs” and “candidate SNs”. In the context of the present disclosure, the term “potential target PSCells” may be interchangeably used with “target PSCells”, “candidate target PSCells” and “candidate PSCells”.

For the CHO with candidate SCGs, the 3GPP RAN2 #121bis meeting agreed that when both CHO execution condition(s) and CPC execution condition(s) are fulfilled, both CHO and CPC are executed. The baseline is that the UE (always) waits until both CHO execution condition(s) and CPC execution condition(s) are fulfilled. However, failures are likely to happen due to the requirements of fulfilling both execution condition(s). Enhancements on CHO in MR-DC scenarios are still needed.

In view of the above discussions, embodiments of the present disclosure provide a solution for a CPAC-associated CHO procedure. In an aspect of the solution, a first network device determines a CHO-only configuration. The CHO-only configuration does not support a terminal device to perform a CPAC in a MR-DC environment. The first network device transmits, to the terminal device, the CHO-only configuration for deployment by the terminal device in the event that a CPAC execution condition in the MR-DC environment is not fulfilled by the terminal device. Through the proposed solution, a CHO-only configuration may be provided to complement the legacy CPAC-associated CHO configuration. Thus, the communication reliability and efficiency may be improved.

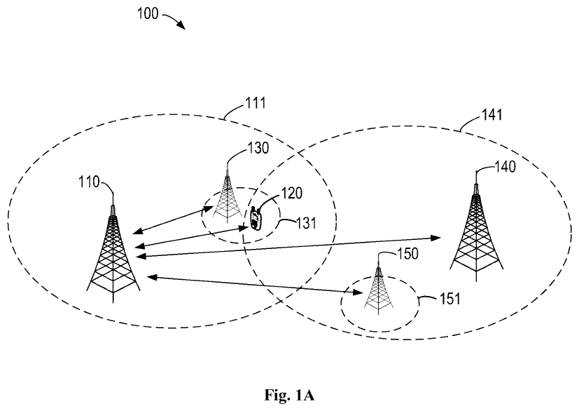

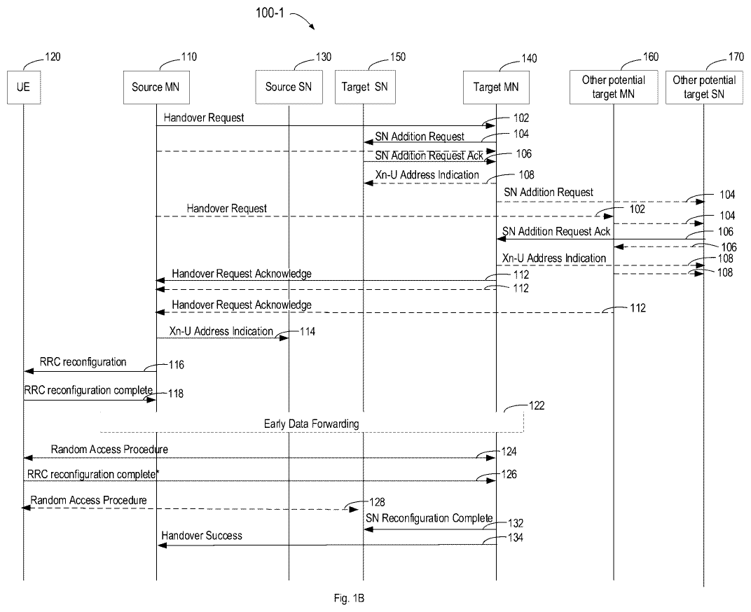

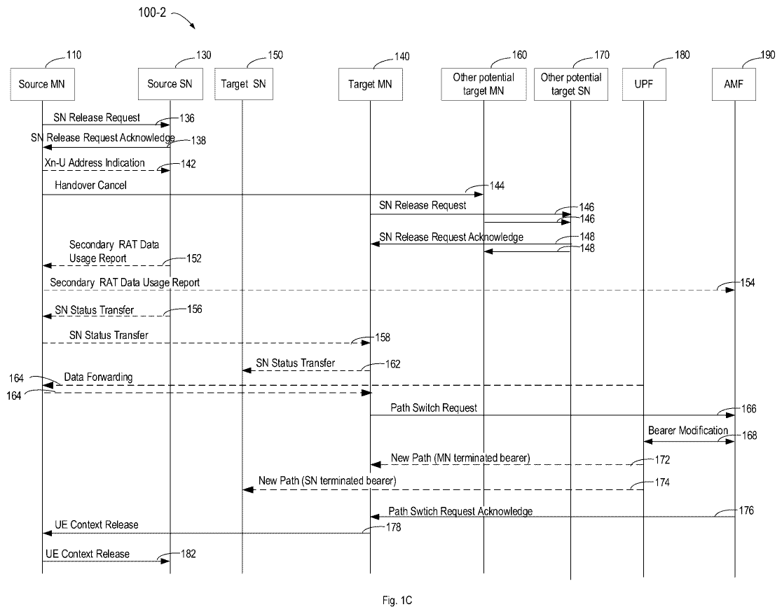

Principles and implementations of embodiments of the present disclosure will be described in detail below with reference to the figures. FIG. 1A illustrates a schematic diagram of an example communication environment 100 in which embodiments of the present disclosure can be implemented. As shown in FIG. 1A, the communication environment 100 may include a network device 110 and a terminal device 120. The network device 110 provides a cell 111 and the terminal device 120 is located in the cell 111 and served by the network device 110.

The communication environment 100 may also include one or more other network devices such as network devices 130, 140 and 150. The network device 130 provides a cell 131. The network device 140 provides a cell 141, and the network device 150 provides a cell 151. It should be noted that the number of the cells are not limited to one, and multiple cells may be provided by the network devices 130, 140 and 150.

It is assumed that the terminal device 120 may establish connections with two network devices simultaneously (i.e., DC). For example, the network device 110 may serve as a MN for the terminal device 120, and the network device 130 may serve as a SN for the terminal device 120. For convenience, the network devices 110 and 130 may be referred to as a MN 110 and a SN 130, respectively. Although only the cell 111 and cell 131 are shown, the MN 110 and SN 130 may provide multiple cells, and these cells may form a MCG and a SCG for the terminal device 120. Assuming that the cell 111 is a primary cell (i.e., PCell) in the MCG and the cell 131 is a primary cell (i.e., PSCell) in the SCG.

The MN 110 may communicate with the terminal device 120 via a channel such as a wireless communication channel. The SN 130 may communicate with the terminal device 120 via a channel such as a wireless communication channel. In addition, the network devices 110, 130, 140 and 150 may communicate with each other via an Xn interface. For example, the SN 130 may communicate with the MN 110 via an Xn interface.

It is to be understood that the number of devices or cells in FIG. 1A is given for the purpose of illustration without suggesting any limitations to the present disclosure. The communication environment 100 may include any suitable number of network devices and/or terminal devices and/or cells adapted for implementing embodiments of the present disclosure.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as institute for electrical and electronics engineers (IEEE) 802.11 and the like, and/or any other protocols currently known or to be developed in the future. Moreover, such communication may utilize any appropriate wireless communication technology, comprising but not limited to: code division multiple access (CDMA), frequency division multiple access (FDMA), time division multiple access (TDMA), frequency division duplex (FDD), time division duplex (TDD), multiple-input multiple-output (MIMO), orthogonal frequency division multiple (OFDM), discrete fourier transform spread OFDM (DFT-s-OFDM) and/or any other technologies currently known or to be developed in the future.

In some embodiments, the network device 110 may configure candidate target MN(s) and candidate target SN(s) for the terminal device 120. Assuming that the network devices 140 and 150 are configured as a candidate target MN and a candidate target SN for the terminal device 120. Thus, the network devices 140 and 150 may be referred to as a target MN 140 and target SN 150, respectively. The cell 141 and 151 are configured as a candidate PCell and a candidate PSCell for the terminal device 120. It is to be understood that the numbers of candidate target MNs, candidate target SNs, candidate PCells or candidate PSCells in FIG. 1A are not limited to one. Multiple candidate target MNs and multiple candidate target SNs may be configured for the terminal device 120. One or more cells of each candidate target MN may be configured as candidate PCell(s) for the terminal device 120. One or more cells of each candidate target SN may be configured as candidate PSCell(s) for the terminal device 120.

FIGS. 1B and 1C illustrate an example signaling chart illustrating a CHO with SN procedure 100-1 and 100-2 in a related solution. The procedure 100-2 is a continuation of the procedure 100-1. For the purpose of discussion, the procedure 100-1 and 100-2 will be described with reference to FIG. 1A. The procedure 100-1 and 100-2 may involve the terminal device 120 and network devices 110, 130-150 as illustrated in FIG. 1A. It is to be understood that the steps and the order of the steps in FIGS. 1B and 1C are merely for illustration, and not for limitation. In some embodiments, the network devices 110 and 130 may be a source MN and a source SN, respectively. In some embodiments, the network devices 140 and 150 may be a target MN and a target SN, respectively. The procedure 100-1 and 100-2 may also involve other potential target MN(s) 160, other potential target SN(s) 170, user plane function (UPF) 180 and access and mobility management function (AMF) 190, which are not shown in FIG. 1A.

FIGS. 1B and 1C illustrate an example CHO with SN procedure 100-1 and 100-2. The CHO with SN procedure is used for configuration and execution of CHO with SN. This procedure includes the cases where the SN is kept, changed or added. If the SN is kept, the UE context at the SN is kept. If the SN is changed, the UE context at the source SN is moved to the target SN. It should be noted that for a CHO without SN change, the source SN 130 and the target SN 150 shown in FIGS. 1B and 1C may be implemented as the same node. It should be noted that for a CHO with SN addition, the source SN 130 and steps involving the source SN 130 in FIGS. 1B and 1C may be ignored.

As shown in FIG. 1B, the source MN 110 transmits 102-1 a Handover Request message to the target MN 140. In some embodiments, the source MN 110 may also transmit 102-3 a Handover Request message to the potential target MN(s) 160 (if configured). The source MN 110 starts a CHO procedure by initiating the Xn Handover Preparation procedure including MCG configuration. If the UE 120 is configured with an SCG, the Xn Handover Preparation procedure also includes SCG configuration. The source MN 110 includes the (source) SN UE XnAP ID, SN ID, the UE context in the source SN and the Conditional Handover Information Request IE in the Handover Request message.

It should be noted that in case of the CHO with/without SN change, the source MN 110 may trigger a MN-initiated SN Modification procedure (to the source SN 130) to retrieve the current SCG configuration, if configured, prior to the transmission steps 102-1 and 102-3.

If the target MN 140 decides to keep the UE context in the SN, the target MN 140 transmits the SN Addition Request message to the SN including the SN UE XnAP ID as a reference to the UE context in the SN that was established by the source MN 110. If the target MN 140 decides to change the SN allowing delta configuration, the target MN 140 transmits 104 the SN Addition Request message to the target SN 150 including the UE context in the source SN 130 that was established by the source MN 110. Otherwise, the target MN 140 may send the SN Addition Request message to the target SN 150 including neither the SN UE XnAP ID nor the UE context in the source SN 130 that was established by the source MN 110. Within the SN Addition Request message, the target MN 140 also includes the CHO related information, i.e., the source MN 110 ID and the MN UE XnAP ID in the source MN 110, in order to indicate that the SN Addition Preparation procedure is triggered in relation to a CHO and to enable the SN to identify requests related to the same UE. It should be noted that the target MN 140 and other potential target MNs 160 may trigger the SN Addition Preparation procedure to the same target SN.

It should be noted that the target MN 140 and other potential target MNs 160 may trigger the SN Addition Preparation procedure to the same (target) SN. It should be noted that the source MN 110 may initiate additional Xn Handover Preparation procedures towards the same or other target MNs. Based on each Xn Handover Preparation procedure, each target MN may decide to trigger SN Addition Preparation procedure.

The target SN replies 106 with the SN Addition Request Acknowledge message. The target SN may include the indication of the full or delta RRC configuration. It should be noted that in CHO with SCG configuration, it is up to the target MN implementation to make sure that the CG-Config provided from the target SN can be used in all CHO preparations. For the SN terminated bearers using MCG resources, the target MN 140 provides 108 Xn-U DL TNL address information in the Xn-U Address Indication message.

The target MN transmits 112 Handover Request Acknowledge message to the source MN 110. The target MN includes within the Handover Request Acknowledge message the MN RRC reconfiguration message to be sent to the UE 120 in order to perform the conditional handover, and may also provide forwarding addresses to the source MN 110. If PDU session split is performed in the target side during handover procedure, more than one data forwarding addresses corresponding to each node are included in the Handover Request Acknowledge message. The target MN 140 indicates to the source MN 110 that the UE context in the SN is kept if the target MN 140 and the SN decided to keep the UE context in the SN in step 104 and step 106.

The source MN 110 transmits 114 the Xn-U Address Indication message to the source SN 130. This Xn-U Address Indication message notifies conditional handover to the source SN 130, which may decide to perform, if applicable, early data forwarding for SN-terminated bearers, together with the sending of an Early Status Transfer message to the source MN 110.

It should be noted that separate Xn-U Address Indication procedures may be initiated to provide different forwarding addresses of the prepared conditional handovers. In this case, it is up to the source MN and SN implementations to make sure that the Early Status Transfer message(s) from the source SN, if any, is forwarded to the right target MN. The Xn-U Address Indication procedure may further be initiated to indicate to the source SN to stop already initiated early data forwarding for some SN-terminated bearers, if they are no longer subject to data forwarding due to the modification or cancellation of the prepared conditional handovers.

The source MN 110 transmits 116 an RRC reconfiguration message to the UE 120, including the CHO configuration, i.e. a list of RRC reconfiguration* messages and associated execution conditions, in which each RRC reconfiguration* message contains an MCG configuration and possibly an SCG configuration in the RRC reconfiguration** message received from the target SN 150 in step 106.

The UE 120 applies the RRC reconfiguration message received in at step 116, stores the CHO configuration and replies 118 to the source MN 110 with an RRC reconfiguration complete message. The source MN 110, source SN 130, target MN 140 and target SN 150 may perform 122 an early data forwarding procedure. The UE 120 maintains connection with the source MN 110.

If the UE 120 is configured with a PSCell, with the source PSCell, after receiving CHO configuration, the UE 120 starts evaluating the CHO execution condition for the candidate cell(s). At step 124, if at least one CHO candidate cell satisfies the corresponding CHO execution condition, the UE 120 detaches from the source MN 110, applies the stored corresponding configuration for that selected candidate cell, synchronizes to that candidate cell and completes the RRC handover procedure by sending 126 RRC reconfiguration complete* message to the target MN 140. If the stored configuration for the selected candidate cell includes an SCG configuration, the UE 120 includes an embedded SN RRCReconfigurationComplete** message for the target SN 150. The UE 120 releases stored CHO configurations after successful completion of RRC handover procedure 134.

It should be noted that in case the target SN includes the indication of the full RRC configuration, the source MN 110 performs release of the SN terminated radio bearer configuration and release and add of the NR SCG configuration part towards the UE.

If configured with bearers requiring SCG radio resources, the UE 120 synchronizes 128 to the target SN 150. It should be noted that the order the UE performs Random Access towards the target MN 140 (step 124) and performs the Random Access procedure towards the target SN 150 (step 128) is not defined.

If the RRC connection reconfiguration procedure was successful, the target MN 140 informs 132 the target SN 150 via SN Reconfiguration Complete message. The target MN 140 transmits 134 the Handover Success message to the source MN 110 to inform that the UE has successfully accessed the target cell.

Turning to FIG. 1C, the source MN 110 transmits 136 SN Release Request message to the source SN 130 including a Cause indicating MCG mobility. The source MN 110 indicates to the source SN 130 that the UE context in SN is kept, if it receives the indication from the target MN 140. The source SN 130 acknowledges 138 the release request. The source MN 110 transmits 142 Xn-U Address Indication message to the source SN 130 to transfer data forwarding information. More than one data forwarding addresses may be provided if the PDU session is split in the target side. The source MN 110 transmits 144 the Handover Cancel message toward the other signaling connections or other target MNs 160, if any, to cancel CHO for the UE.

If the target MN 140 is configured with other candidate PCell(s) associated with other target SN(s) 170 than the target SN 150, the target MN 140 transmits 146 the SN Release Request message(s) to the corresponding target SN(s) 170. Other target MN(s) 160 send(s) 146 the SN Release Request message(s) to other target SN(s) 170, if configured. The other target SN(s) 170 acknowledges 148 the release request.

The source SN 130 transmits 152 the Secondary RAT Data Usage Report message to the source MN 110 and includes the data volumes delivered to and received from the UE over the NR/E-UTRA radio. It should be noted that the order that the source SN 130 transmits the Secondary RAT Data Usage Report message and performs data forwarding with MN/target SN 150 is not defined. The source SN 130 may send the report when the transmission of the related QoS is stopped. The source MN 110 transmits 154 the Secondary RAT Data Usage Report message to AMF to provide information on the used NR/E-UTRA resource.

For bearers using RLC AM, the source MN 110 transmits 158 the SN Status Transfer message to the target MN 140, including, if needed, SN Status received 156 from the source SN 130. The target MN 140 forwards 162 the SN Status to the target SN 150, if needed.

If applicable, data forwarding 164 takes place from the source side (i.e. source MN 110 or source SN 130). If the SN is kept, data forwarding may be omitted for the SN terminated bearers or QoS flows kept in the SN.

At steps 166-176, the target MN 140 initiates the Path Switch procedure. If the target MN 140 includes multiple DL TEIDs for one PDU session in the Path Switch Request message, multiple UL TEID of the UPF 180 for the PDU session should be included in the Path Switch ACK message in case there is TEID update in UPF 180. It should be noted that if new UL TEIDs of the UPF for SN are included, the target MN 140 performs MN initiated SN Modification procedure to provide them to the SN.

The target MN 140 initiates 178 the UE Context Release procedure towards the source MN 110. Upon reception of the UE Context Release message from source MN 110, the source SN 110 releases 182 control-plane related resources associated to the UE context towards the source MN 110. Any ongoing data forwarding may continue. The SN shall not release the UE context associated with the target MN 140 if the UE contest kept indication was included in the SN Release Request message in step 136.

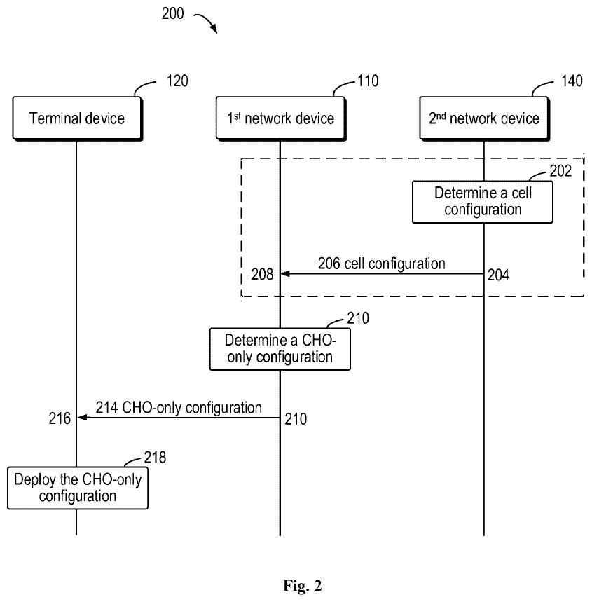

FIG. 2 illustrates a schematic diagram illustrating a process 200 of communication according to embodiments of the present disclosure. For the purpose of discussion, the process 200 will be described with reference to FIG. 1A. The process 200 may involve the terminal device 120 and the network devices 110 and 140 as illustrated in FIG. 1A. It is to be understood that the steps and the order of the steps in FIG. 2 are merely for illustration, and not for limitation. In some embodiments, the network devices 110 and 140 may be referred to as a first network device 110 and a second network device 140, respectively. In some embodiments, the first network device 110 may be a source MN and the second network device 140 may be a candidate target MN.

As shown in FIG. 2, the first network device 110 determines 210 a CHO-only configuration 214. The CHO-only configuration 214 does not support the terminal device 120 to perform a CPAC in a MR-DC environment. The first network device 110 transmits, to the terminal device 120, the CHO-only configuration 214 for deployment by the terminal device 120 in the event that a CPAC execution condition in the MR-DC environment is not fulfilled by the terminal device 120.

The terminal device 120 receives 216 the CHO-only configuration 214 from the first network device 110. When a CPAC execution condition is not fulfilled, the terminal device 120 deploys 218 the CHO-only configuration 214. In this way, a CHO-only configuration may be provided to complement the CPAC-associated CHO configuration. Thus, the communication reliability and efficiency may be improved.

In the context of the present disclosure, the term “CHO-only configuration” may be defined as that when the CHO-only configuration is deployed by the terminal device, the terminal device may only perform a CHO without performing a CPAC, and thus would finally connect only to a MN without connecting to a SN after the CHO. In the context of the present disclosure, the term “CPAC-associated CHO configuration” refers to the legacy CHO configuration in MR-DC. When the CPAC-associated CHO configuration is deployed by the terminal device, the terminal device may perform a CHO and a CPAC, and thus would finally connect to both a MN and a SN after the CHO. In general, the CPAC-associated CHO configuration may be deployed only when both the CHO execution condition(s) and the CAPC execution condition(s) are fulfilled; in contrast, the CHO-only configuration may be deployed when the CHO-only execution condition(s) is fulfilled while the CAPC execution condition(s) is not fulfilled.

Hereinbefore, some embodiments of CHO in MR-DC scenarios are described in general terms. Hereinafter, some more embodiments of the CHO in MR-DC scenarios will be further detailed in regard to various specific aspects.

The first specific aspect of the CHO in MR-DC scenarios is that it is up to which node to decide whether a CHO-only configuration is needed. In some embodiments, the first network device 110 may decide that the CHO-only configuration is needed. For example, an indication may be used in the handover request message to request the second network device 140 to prepare the CHO-only configuration. Alternatively, the second network device 140 may decide that the CHO-only configuration is needed. For example, the first network device 110 may provide the second network device 140 with the measurement results for each candidate PCell and PSCell associated with the second network device 140. Based on the measurement results, the second network device 140 may decide whether to provide the CHO-only configuration.

In some embodiments, the CHO-only configuration 214 may include a cell configuration for at least one candidate target cell associated with the second network device 140. The CHO-only configuration 214 may also include at least one CHO-only execution condition for the at least one candidate target cell. The at least one CHO-only execution condition needs to be fulfilled in order to execute the cell configuration for the at least one candidate target cell associated with the second network device 140. For example the cell 141 as shown in FIG. 1A may be configured as a candidate target cell (i.e., a candidate PCell) for the terminal device 120. The CHO-only configuration 214 may include a cell configuration and a CHO-only execution condition for the cell 141. The CHO-only execution condition needs to be fulfilled in order to execute the cell configuration for the cell 141, i.e., to deploy the cell configuration by the terminal device 120 for connection with the cell 141.

In some embodiments, the second network device 140 may determine 202 a cell configuration 206 for at least one candidate target cell associated with the second network device 140. The cell configuration 206 may be associated with the CHO-only configuration 214. The second network device 140 may transmit 202 the cell configuration 206 to the first network device 110.

In some embodiments, the first network device 110 may determine the at least one CHO-only execution condition for the at least one candidate target cell and determine the CHO-only configuration 214 based on the received cell configuration 206 and the determined CHO-only execution condition.

In some embodiments, the second network device 140 may determine the at least one CHO-only execution condition for the at least one candidate target cell and transmit the at least one CHO-only execution condition to the first network device 110. The second network device 140 may determine the CHO-only configuration 214 based on the received cell configuration 206 and the received CHO-only execution condition. For example, the second network device 140 may determine the CHO-only configuration 214 and transmit the CHO-only configuration 214 to the first network device 110. The first network device 110 may then transmit the received CHO-only configuration 214 to the terminal device 120.

In some embodiments, the first network device 110 may transmit a request for the CHO-only configuration 214 to the second network device 140. In response to receiving the request, the second network device 140 may transmit the CHO-only configuration 214 to the first network device 110.

In some embodiments, when determining the CHO-only configuration, the first network device 110 may transmit, to the second network device 140, a request for the cell configuration for the at least one candidate target cell of CHO-only configuration. In response to receiving the request, the second network device 140 may transmit the cell configuration for the at least one candidate target cell of the CHO-only configuration.

In some embodiments, the first network device 110 may determine that the CHO-only configuration 214 is required for the terminal device 120. Based on the determination, the first network device 110 may transmit, to the second network device 140, a first indication that the CHO-only configuration 214 is required for the terminal device 120, or that the cell configuration associated with the CHO-only configuration 214 is required for the terminal device 120. In some embodiments, the first indication may be comprised in a handover request message from the first network device 110 to the second network device 140.

In some embodiments, the first network device 110 may receive, from the terminal device 120, a set of measurement results for a set of cells associated with the second network device 140 and transmit the set of measurement results to the second network device 140. Based on the set of measurement results associated with the set of cells, the second network device 140 may determine that the cell configuration 206 for at least one candidate target cell among the set of cells is required for the terminal device 120.

In some embodiments, the CPAC-associated CHO configuration may comprises a CHO configuration portion and a CPAC configuration portion. When determining the CHO-only configuration 214, the first network device 110 may receive, from the second network device 140, an indication that the CHO-only configuration 214 is identical with the CHO configuration portion of the CPAC-associated CHO configuration. In some embodiments, the first network device 110 may transmit, to the terminal device 120, an indication that the CHO-only configuration 214 is identical with the CHO configuration portion of the CPAC-associated CHO configuration.

In some embodiments, the at least one candidate target cell in the CHO-only configuration is identical with the candidate target cell in the CPAC-associated CHO configuration.

In some embodiments, the at least one candidate target cell in the CHO-only configuration is different from the candidate target cell in the CPAC-associated CHO configuration.

The second specific aspect of the CHO in MR-DC scenarios is how to indicate the terminal device to deploy the CHO-only configuration when the CAPC execution condition is not fulfilled. For example, in some scenarios, the CHO execution condition in the CPAC-associated CHO configuration is fulfilled but the CPAC execution condition in the CPAC-associated CHO configuration is not fulfilled. For simplicity, in some embodiments, the CPAC execution condition not being fulfilled indicates that the CHO execution condition in the CPAC-associated CHO configuration is fulfilled but the CPAC execution condition in the CPAC-associated CHO configuration is not fulfilled.

In some embodiments, the first network device 110 may transmit, to the terminal device 120, a timer for deploying the CHO-only configuration 214 by the terminal device 120. The terminal device 120 may receive the timer from the first network device 110. The terminal device 120 mays tart the timer responsive to the CHO execution condition being fulfilled but the CPAC execution condition not being fulfilled; and stop the timer responsive to both the CHO execution condition and the CPAC execution condition being fulfilled. If the both the CHO execution condition and the CPAC execution condition are fulfilled, the timer may be stopped and the terminal device may deploy the CPAC-associated CHO configuration. Responsive to the expiry of the timer (i.e., the timer is not stopped after being started), the terminal device 120 may deploy the CHO-only configuration 214. For example, a timer may be introduced to trigger the CHO-only configuration. The terminal device may start the timer upon detection the CHO execution condition in the CPAC-associated CHO configuration is fulfilled, and stops the timer upon detection the CPAC execution condition in the CPAC-associated CHO configuration is fulfilled. Responsive to the expiry of the timer, the terminal device may apply the CHO-only configuration.

In some embodiments, a time offset may be introduced to trigger the CHO-only configuration. The first network device 110 may transmit, to the terminal device 120, a time offset for deploying the CHO-only configuration 214 by the terminal device 120. The terminal device 120 may receive the time offset from the first network device 110. The terminal device 120 mays deploy the CHO-only configuration 214 responsive to a duration of the CHO execution condition being fulfilled but the CPAC execution condition not being fulfilled by the time offset.

In some embodiments, the first network device 110 may transmit, to the terminal device 120, an indication to deploy the CHO-only configuration 214 by the terminal device 120. For example, an indicator may be introduced to indicate the terminal device to perform the CHO-only configuration.

In some embodiments, the terminal device 120 may receive, from the first network device 110, an indication to deploy the CHO-only configuration 214 responsive to the CHO execution condition being fulfilled but the CPAC execution condition not being fulfilled. The indication to deploy the CHO-only configuration 214 may be comprised in RRC signaling between the terminal device 120 and the first network device 110. For example, an indicator in the RRC reconfiguration may be used to indicate the terminal device to perform the CHO-only configuration responsive to the CPAC execution condition not being fulfilled.

In some embodiments, the first network device 110 may receive, from the terminal device 120, an indication that a CHO execution condition is fulfilled but the CPAC execution condition is not fulfilled; and transmit an indication to deploy the CHO-only configuration 214 to the terminal device 120. The indication to deploy the CHO-only configuration 214 may be comprised in a medium access control (MAC) control element (CE). For example, an indicator in the lower layer command (e.g., a MAC CE) may be used to indicate the terminal device to perform the CHO-only configuration when the CPAC execution condition is not fulfilled. With this option, the terminal device needs to report to the first network device 110 that the CHO execution condition is fulfilled while CPAC execution condition is not fulfilled, e.g., via MAC CE.

The third specific aspect of the CHO in MR-DC scenarios is how to optimize the resource preparation of the network utilizing the CHO-only configuration as a complementary for the CPAC-associated CHO configuration.

In some embodiments, the second network device 140 may receive, from a terminal device 120, an indication that the terminal device 120 has accessed the at least one candidate target cell associated with the CHO-only configuration; and transmit the indication to the first network device 110. For example, when the terminal device 120 successfully connects to the second network device 140, the terminal device 120 may indicate to the second network device 140 that the CHO-only configuration is performed. After that, the second network device 140 may indicate to the first network device 110 that the CHO-only configuration is performed by the terminal device 120, e.g., via the handover success procedure or access and mobility indication procedure. The first network device 110 may optimize the conditional handover related resource management based on the CHO success report.

In some embodiments, when the terminal device 120 detects a CHO-only failure event with a target network device (e.g., the second network device 140), the terminal device 120 may inform the network about the failure. A failure type may be used to indicate the CHO-only failure. In some cases, if the terminal device 120 connects another network device (which may be another target network device or a non-target network device), this network device may receive the CHO-only failure indication and indicate the CHO-only failure to the first network device 110. In some cases, if the terminal device 120 connects to the first network device 110, the terminal device 120 may directly inform the first network device 110 about the CHO-only failure. Based on the conditional handover failure report, the first network device 110 may be able to optimize the conditional handover related resource management. In some embodiments, the network device connected with the terminal device may also indicate the CHO-only failure to the target network device associated with the CHO-only failure event. Based on the conditional handover failure report, the target network device may be able to optimize the conditional handover related resource management.

For example, if the terminal device 120 has failed access to one (e.g., a first candidate target cell) of the at least one candidate target cell associated with the second network device 140 based on the CHO-only configuration 214, the terminal device 120 may connect to another network device and transmit an indication to the connected network device (e.g., a third network device) that the terminal device 120 has failed access to the first candidate target cell.

In some embodiments, the third network device may be the first network device. Alternatively, the third network device may be different from the first network device 110. The first network device 110 may receive, from the third network device, an indication that the terminal device 120 has failed access to the at least one candidate target cell associated with the second network device 140. In some embodiments, the third network device may be different from the second network device 140. The second network device 140 may receive, from the third network device, an indication that the terminal device 120 has failed access to the first candidate target cell.

In some embodiments, the indication that the terminal device 120 has failed access to the first candidate target cell may comprise information associated with the first candidate target cell that the terminal device 120 has failed access to. The indication may further comprise information associated with a second candidate target cell selected from among the set of candidate target cells after the terminal device 120 has failed access to the first candidate target cell. The indication may further comprise a type of a first configuration deployed by the terminal device 120 for connection with the first candidate target cell. The type of the first configuration may be a CHO-only configuration or a CPAC-associated CHO configuration. The indication may further comprise a type of a second configuration deployed by the terminal device 120 for connection with the second candidate target cell. The type of the second configuration may be a CHO-only configuration or a CPAC-associated CHO configuration.

The fourth specific aspect of the CHO in MR-DC scenarios is how to select the target cell by the terminal device for fast recovery when the CHO-only configuration execution is also failed. The terminal device may deploy the CPAC-associated CHO configuration when both the CHO execution condition and the CPAC execution condition are fulfilled. The terminal device may deploy the CHO-only configuration when the CHO execution condition is fulfilled but the CPAC execution condition is not fulfilled. However, when deploying the CHO-only configuration, there is a probability that the CHO-only configuration execution for connection with a candidate target cell is failed. If the CHO-only configuration execution is failed, the terminal device may perform a cell selection. If the selected cell is a candidate target cell (e.g., the cell 141), a fast recovery of the connection may be performed.

In some embodiments, the first network device 110 may transmit, to the terminal device 120, an indication of deploying the CHO-only configuration 214 in the case that the terminal device 120 selects a second candidate target cell from among the set of candidate target cells after a failed access to a first candidate target cell from among the set of candidate target cells. After a failed access to a first candidate target cell from among the set of candidate target cells based on the CHO-only configuration 214, the terminal device 120 may select a cell. If the selected cell is from among the set of candidate target cells, the terminal device 120 may deploy the CHO-only configuration 214 for connection with the selected cell based on the indication of deploying the CHO-only configuration 214 for recovery.

In some embodiments, the first network device 110 may transmit, to the terminal device 120, an indication of deploying the indication of deploying the CPAC-associated CHO configuration in the case that the terminal device 120 selects a second candidate target cell from among the set of candidate target cells after a failed access to a first candidate target cell from among the set of candidate target cells. After a failed access to a first candidate target cell from among the set of candidate target cells based on the CHO-only configuration 214, the terminal device 120 may select a cell. If the selected cell is from among the set of candidate target cells, the terminal device 120 may deploy the CPAC-associated CHO configuration for connection with the selected cell based on the indication of deploying the CPAC-associated CHO configuration for recovery.

In some embodiments, the CHO-only configuration 214 may comprise the indication of deploying the CHO-only configuration 214 for recovery. Alternatively, the indication of deploying the CHO-only configuration 214 for recovery may be not comprised in the CHO-only configuration 214.

In some embodiments, the CPAC-associated CHO configuration may comprise the indication of deploying the CPAC-associated CHO configuration for recovery. Alternatively, the indication of deploying the CPAC-associated CHO configuration for recovery may be not comprised in the CPAC-associated CHO configuration.

For example, an indicator may be used to indicate the terminal device 120 to perform one of the CHO-only configuration or CPAC-associated CHO configuration if the selected cell is a target candidate cell. The indicator may be added in the CHO-only configuration, or CPAC-associated CHO configuration, or outside the CHO-only configuration and CPAC-associated CHO configuration.

In some embodiments, the terminal device 120 may deploy the CHO-only configuration 214 in absence of the indication for recovery in the case that the terminal device 120 selects a second candidate target cell from among the set of candidate target cells after a failed access to a first candidate target cell from among the set of candidate target cells.

In some embodiments, the terminal device 120 may deploy the CPAC-associated CHO configuration in absence of the indication for recovery in the case that the terminal device 120 selects a second candidate target cell from among the set of candidate target cells after a failed access to a first candidate target cell from among the set of candidate target cells.

The fifth specific aspect of the CHO in MR-DC scenarios is how to handle the identity allocation for the CHO-only configuration. Each instance of the CPAC-associated CHO configuration and each instance of the CHO-only configuration shall be associated with a unique identity (e.g., CondReconfigId) to identify the configuration. However, due to the limited number of identities, how to handle the identity allocation for the CHO-only configuration needs to be considered.

In some embodiments, the CHO-only configuration 214 may comprises a set of first configurations associated with a set of candidate target cells. The first network device 110 may transmit, to the terminal device 120, a CPAC-associated CHO configuration. The CPAC-associated CHO configuration may comprises a set of second configurations associated with the set of candidate target cells.

In some embodiments, one of the set of first configurations may be associated with an identity that is different from an identity associated with one of the set of second configurations. In some embodiments, the first configurations may be associated with the set of second configurations.

For example, each instance of CHO-only configuration may be allocated with an identity, which is different from the identities of the instances in the CPAC-associated CHO configuration. In this case, an indicator may be used to indicate the association between the CPAC-associated CHO configuration and the CHO-only configuration. For example, the maximum number of configurations may be 8, where 4 configurations may be for CPAC-associated CHO configuration, while other 4 configurations may be for CHO-only configuration. In this case, three bits may be used for the identity allocation. In an example implementation, the CPAC-associated CHO configuration may comprise four configurations with ID 1, ID 2, ID 3, ID 4, respectively. The CHO-only configuration may comprise four configurations with ID 5, ID 6, ID7, ID 8, respectively. The terminal device may receive an indication of correlation between the CPAC-associated CHO configuration and the CHO-only configuration.

In another example, each instance of CHO-only configuration may be allocated with an identity, which is different from the identity of CPAC-associated CHO configuration. For example, the maximum number of configurations may be 8. There may be 8 configurations for CPAC-associated CHO configuration, and 8 configurations for CHO-only configuration. In this case, the terminal device shall consider there are 8 but not 16 configurations for the total configurations. In this case, four bits are used for the identity allocation.

In some embodiments, one of the set of first configurations and one of the set of second configurations may be associated with the same identity. For example, each instance of the CHO-only configuration may be allocated with the same identity of CPAC-associated CHO configuration. In other words, the instance of the CHO-only configuration and the instance of the CPAC-associated CHO configuration associated with the same candidate target cell may be allocated with the same identity.

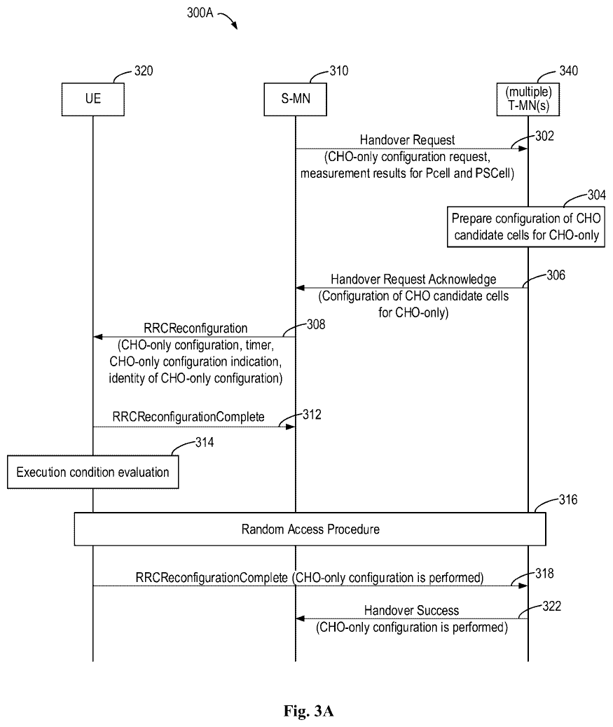

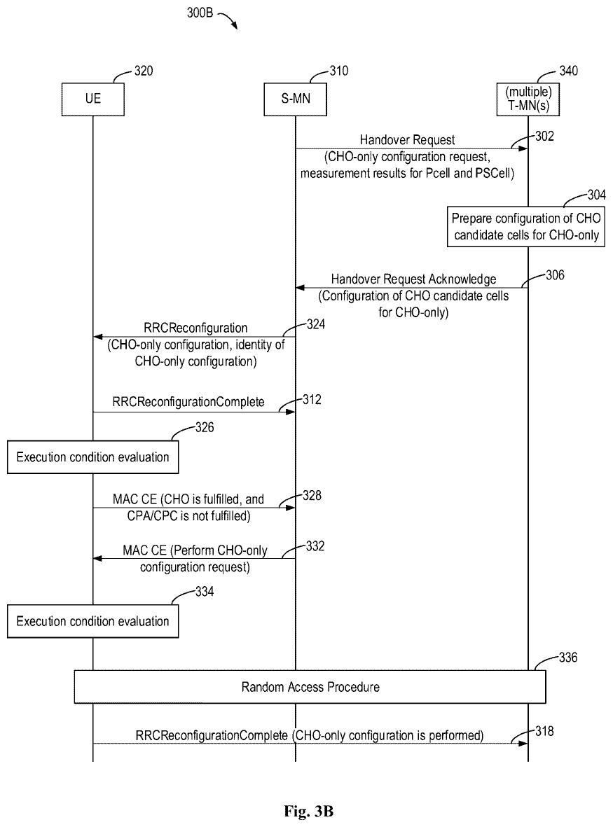

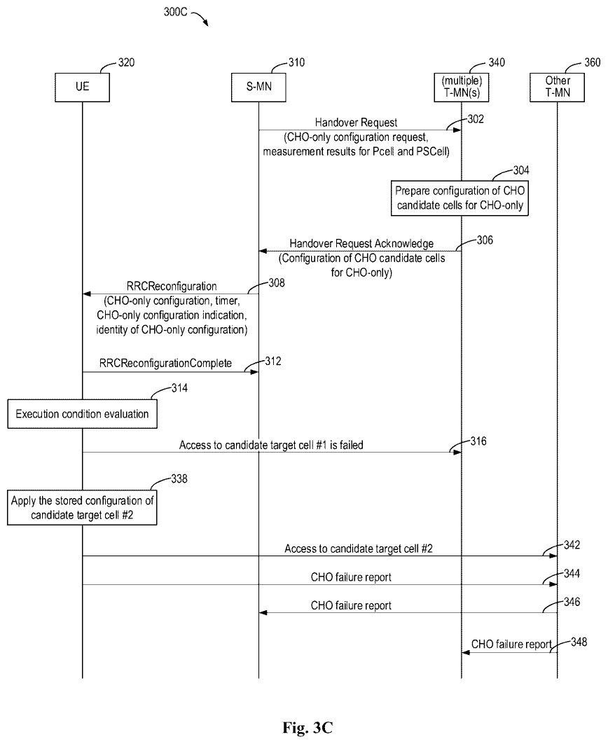

FIG. 3A illustrates a schematic diagram illustrating an example process 300A of for a successful handover using CHO-only configuration via RRC configuration according to embodiments of the present disclosure. It is noted that the process 300A can be considered as a more specific example of the process 200 of FIG. 2. The example implementation of FIG. 3A is depicted and will be described from perspectives of a UE 320, a source master node (S-MN) 310 and at least one target master node (T-MN) 340. It should be understood that the UE 320, the S-MN 310 and the T-MN 340 may correspond to the terminal device 120, the network device 110 and the network device 140 in FIG. 1A, respectively. It is to be understood that process 300A may further include additional blocks not shown and/or omit some shown blocks, and the scope of the present disclosure is not limited in this regard.

The S-MN 310 may serve as a source MN for the UE 320. The T-MN 340 may be configured as a candidate target MN for the UE 320. In some embodiments, the S-MN 310 may transmit a CPAC-associated CHO configuration to the UE 320. The CPAC-associated CHO configuration may include both a CHO configuration and a CPAC configuration. The CHO configuration in the CPAC-associated CHO configuration may include the configuration of CHO candidate cell(s) generated by the T-MN 340 and the execution condition(s) generated by the S-MN 310. The CPAC configuration in the CPAC-associated CHO configuration may include the configuration of CPAC candidate cell(s) generated by the T-SN (not shown) and the execution condition(s) generated by the T-MN 340 or S-MN 310.

Alternatively or additionally, the S-MN 310 may transmit a CHO-only configuration to the UE 320. The CHO-only configuration may include the configuration of CHO candidate cell(s) generated by the T-MN 340 and the execution condition(s) generated by the S-MN 310 or T-MN 340. In one example, the CHO-only configuration may be different from the CHO configuration within the CPAC-associated CHO configuration. In another example, the CHO-only configuration may be the same with the CHO configuration within the CPAC-associated CHO configuration.

As shown in FIG. 3A, the S-MN 310 may transmit 302 a message to the T-MN(s) 340 for one or more candidate cells belonging to the T-MN(s) 340. The message may include the measurement results for each candidate PCell and/or PSCell associated with the T-MN(s) 340. The message may be included in a Handover Request message or a CPAC-associated CHO configuration request information element.

Alternatively or additionally, the message may include an indicator to request the T-MN(s) 340 to prepare the CHO-only configuration for the one or more candidate cells. In one example, the indicator may be included in the CPAC-associated CHO configuration request information element, which indicates that the CHO-only configuration should be provided by the T-MN 340, in addition to the CPAC-associated CHO configuration.

In another example, the indicator may be included in the Handover Request message, which is separately from the CPAC-associated CHO configuration request information element. With this indicator, the T-MN 340 should provide the CHO-only configuration, no matter the CPAC-associated CHO configuration is needed or not.

In another example, the indicator may be used to request the T-MN(s) 340 to prepare the cell configuration for the one or more candidate cells associated with the CHO-only configuration.

The T-MN 340 may prepare 304 the CHO-only configuration for the candidate cells, or the cell configurations of the candidate cells associated with the CHO-only configuration. In one example, if the indicator for the CHO-only configuration is included in the Handover Request message, the T-MN 340 may prepare the CHO-only configuration, or the cell configurations of the candidate cells associated with the CHO-only configuration accordingly. In another example, if the measurement results for candidate PCell and/or PSCell is included in the Handover Request message, the T-MN 340 determines whether to prepare the CHO-only configuration based on the measurement results. For example, if the measurement result of the candidate cell is below a threshold, the T-MN 340 may prepare the CHO-only configuration.

The example process 300A is illustrated such that the CHO-only configuration may be prepared by the T-MN 340. It is to be understood that it should not be seen as limiting the scope of the present disclosure. In another example implementation, the T-MN 340 may prepare the cell configurations of the candidate cells associated with the CHO-only configuration. The S-MN 310 may determine the CHO-only execution conditions associated with the cell configurations of the candidate cells. The S-MN 310 may determine the CHO-only configuration based on the cell configurations prepared by the T-MN 340 and the CHO-only execution conditions. The example process 300A also apply to the scenario where the T-MN 340 determines the cell configurations of the candidate cells associated with the CHO-only configuration, rather than the whole CHO-only configuration.

The T-MN 340 may transmit 306 the Handover Request Acknowledge message to the S-MN 310, which contains the CPAC-associated CHO configuration and the CHO-only configuration. In one example, the CHO-only configuration may be different from the configuration of CHO within the CPAC-associated CHO configuration.

In another example, the CHO-only configuration may be the same with the configuration of CHO within the CPAC-associated CHO configuration. In this case, an indicator is included the Handover Request Acknowledge message, which indicates the CHO-only configuration is the same with the configuration of CHO within the CPAC-associated CHO configuration.

The S-MN 310 may transmit 308 the RRCReconfiguration message to the UE 320, containing the CPAC-associated CHO configuration and the CHO-only configuration. The CHO-only configuration may contain the configuration of CHO candidate cell(s) generated by the T-MN 340 and the execution condition(s) generated by the S-MN 310. Each instance of CHO-only configuration and each instance of CPAC-associated CHO configuration may be associated with an identity, e.g., CondReconfigId, which is used to unique identify the configuration.

In one example, each instance of CHO-only configuration is allocated with an identity, which is different from the identity of CPAC-associated CHO configuration. In this case, an indicator is used to indicate the associated CPAC-associated CHO configuration for the CHO-only configuration. For example, the maximum number of configurations is 8, where 4 configurations are for CPAC-associated CHO configuration, while other 4 configurations are for CHO-only configuration. In this case, three bits are used for the identity allocation.

In another example, each instance of CHO-only configuration is allocated with an identity, which is different from the identity of CPAC-associated CHO configuration. For example, the maximum number of configurations is 8. There are 8 configurations for CPAC-associated CHO configuration, and 8 configurations for CHO-only configuration. However, the UE 320 shall consider there are 8 but not 16 configurations for the total configurations. In this case, four bits are used for the identity allocation.

In yet another example, each instance of CHO-only configuration is allocated with the same identity of CPAC-associated CHO configuration.

The RRCReconfiguration message may contain a timer or time offset used to trigger the CHO-only configuration. The UE 320 may start the timer or time offset upon detection the CHO execution configuration in the CPAC-associated CHO is fulfilled. The UE 320 may stop the timer or time offset upon detection the CPAC execution configuration in the CPAC-associated CHO is fulfilled. Responsive to the expiry of the timer or the time offset, the UE 320 may deploy the CHO-only configuration.

The RRCReconfiguration message may contain an indicator, which is used to indicate the UE 320 to perform the CHO-only configuration when the CHO execution condition is fulfilled while the CPAC execution condition is not fulfilled in the CPAC-associated CHO configuration.

The UE 320 may transmit 312 an RRCReconfigurationComplete message to the S-MN 310. The UE 320 may start 314 evaluating the execution condition. For example, when the CHO execution condition in the CPAC-associated CHO configuration is fulfilled while the CPAC execution condition in the CPAC-associated CHO configuration is not fulfilled, the UE 320 starts evaluating the CHO-only execution condition.

When the CHO-only execution condition is fulfilled, the UE 320 may apply the stored corresponding configuration for the selected candidate cell, and perform 316 the random access procedure to synchronize to that candidate cell. In one example, responsive to the expiry of the timer or the time offset for the CHO-only configuration, if the CPAC execution condition in the CPAC-associated CHO configuration is still not fulfilled, the UE 320 applies the CHO-only configuration and performs the random access to the selected candidate cell in the CHO-only configuration.

The UE 320 may transmit 318 an RRCReconfigurationComplete message to the T-MN 340 to complete the handover procedure. The RRCReconfigurationComplete message may contain an indicator which is used to indicate the T-MN 340 that the CHO-only configuration is performed.

The T-MN 340 may send 322 the handover success message to the S-MN 310. The handover success message includes an indicator to inform the S-MN 310 that the UE 320 has successfully accessed the candidate target cell within the T-MN 340 using the CHO-only configuration.

FIG. 3B illustrates a schematic diagram illustrating an example process 300B of for successful handover using CHO-only configuration via a MAC CE according to embodiments of the present disclosure. It is noted that the process 300B can be considered as a more specific example of the process 200 of FIG. 2. The example implementation of FIG. 3B is depicted and will be described from perspectives of a UE 320, a source master node (S-MN) 310 and at least one target master node (T-MN) 340. It should be understood that the UE 320, the S-MN 310 and the T-MN 340 may correspond to the terminal device 120, the network device 110 and the network device 140 in FIG. 1A, respectively. Similar reference numerals are used to denote the steps or components described in FIG. 3B having the same operations as the steps or components described in FIG. 3A, and detailed description thereof will be omitted. It is to be understood that process 300B may further include additional blocks not shown and/or omit some shown blocks, and the scope of the present disclosure is not limited in this regard.

As shown in FIG. 3B, the S-MN 310 may transmit 324 the RRCReconfiguration message to the UE 320. The RRCReconfiguration message may contain the CPAC-associated CHO configuration and the CHO-only configuration. In one example, each instance of CHO-only configuration and each instance of CPAC-associated CHO configuration may be associated with an identity, e.g., CondReconfigId, which is used to unique identify the configuration. The detailed description is shown in the embodiment 1.

The UE 320 may transmit 312 an RRCReconfigurationComplete message to the S-MN 310. The UE 320 may start 326 evaluating the execution condition of CPAC-associated CHO. If the CHO execution condition in the CPAC-associated CHO configuration is fulfilled, while the CPAC execution condition in the CPAC-associated CHO configuration is not fulfilled, the UE 320 may transmit 328 the execution condition evaluation result to the S-MN 310.

In one example, the UE 320 notifies the S-MN 310 that the CHO execution condition in the CPAC-associated CHO configuration is fulfilled while the CPAC execution condition in the CPAC-associated CHO configuration is not fulfilled. In another example, the UE 320 notifies the S-MN 310 that the CPAC execution condition in the CPAC-associated CHO configuration is not fulfilled. In yet another example, the execution condition evaluation result is sent to the S-MN 310 via MAC CE.

The S-MN 310 may indicate 332 the UE 320 to perform the CHO-only configuration. The indication may be included in the MAC CE sent from the S-MN 310 to the UE 320. The UE 320 may start 334 evaluating the execution condition of CHO-only. When the CHO-only execution condition is fulfilled, the UE 320 applies the stored corresponding configuration for the selected candidate cell, and performs 336 the random access procedure to synchronize to that candidate cell.

FIG. 3C illustrates a schematic diagram illustrating an example process 300C of a fast recovery according to embodiments of the present disclosure. It is noted that the process 300C can be considered as a more specific example of the process 200 of FIG. 2. The example implementation of FIG. 3C is depicted and will be described from perspectives of a UE 320, a source master node (S-MN) 310 and at least one target master node (T-MN) 340. In some embodiments, the process 300C may also involve another master node 360. In some embodiments, the master node 360 may be a target master node (T-MN) different from the T-MN 340. It should be understood that the UE 320, the S-MN 310 and the T-MN 340 may correspond to the terminal device 120, the network device 110 and the network device 140 in FIG. 1A, respectively. Similar reference numerals are used to denote the steps or components described in FIG. 3C having the same operations as the steps or components described in FIG. 3A, and detailed description thereof will be omitted. It is to be understood that process 300C may further include additional blocks not shown and/or omit some shown blocks, and the scope of the present disclosure is not limited in this regard.

As shown in FIG. 3C, the S-MN 310 may transmit 308 the RRCReconfiguration message to the UE 320. The message may include an indicator, which is used to indicate the UE 320 to perform CHO-only configuration or CPAC-associated CHO configuration if selected cell is a candidate target cell when the UE 320 performs cell selection after the conditional handover failure.

In one example, the indicator indicates the UE 320 to perform CHO-only configuration if selected cell is a candidate target cell in the CHO-only configuration. In this case, the indicator may be included in the CHO-only configuration or out of the CHO-only configuration.

In another example, the indicator indicates the UE 320 to perform CPAC-associated CHO configuration if selected cell is a candidate target cell in the CPAC-associated CHO configuration. In this case, the indicator may be included in the CPAC-associated CHO configuration or out of the CPAC-associated CHO configuration.

In another example, the selected cell is a candidate target cell in the CHO-only configuration and in the CPAC-associated CHO configuration. In this case, the indicator is to indicate the UE 320 to perform CHO-only configuration or CPAC-associated CHO configuration if the selected cell is a candidate target cell when the UE 320 performs cell selection after the conditional handover failure.

The UE 320 may transmit 312 an RRCReconfigurationComplete message to the S-MN 310. The UE 320 may start 314 evaluating the execution condition. When the CHO-only execution condition is fulfilled, the UE 320 may apply the stored corresponding configuration for the selected candidate cell, and perform 316 the random access procedure to synchronize to that candidate cell.

When the CHO-only execution is failed, the UE 320 may perform cell selection to find a suitable cell. If the selected cell is a candidate target cell #2, the UE 320 may apply 338 the stored candidate target cell configuration associated to the candidate target cell #2. In one example, the UE 320 applies the stored CHO-only configuration associated to the candidate target cell #2. In another example, the UE 320 applies the stored CPAC-associated CHO configuration associated to the candidate target cell #2.

The UE 320 may perform 342 an access procedure on the candidate target cell #2. The UE 320 may transmit 344 the conditional handover failure report to the T-MN associated with the candidate target cell #2 (e.g., the other T-MN 360 as shown in the FIG. 3C). The conditional handover failure report may include an indicator, which indicates the candidate target cell that the UE 320 selected for recovery, e.g., candidate target cell 2. The conditional handover failure report may include the cell identity of the failed candidate target cell, e.g., candidate target cell #1. The conditional handover failure report may include the conditional handover type towards the failed candidate target cell, e.g., CHO-only or CPAC-associated CHO. The conditional handover failure report may include the conditional handover type towards the selected cell for recovery, e.g., CHO-only. In one example, the conditional handover failure report may be included in the radio link failure (RLF)-report, which may be included in the UE InformationResponse message. In another example, the conditional handover failure report is included in the FailureInfomation message.

The T-MN (e.g., the other T-MN 360 as shown in the FIG. 3C) may forward 346 the conditional handover failure report to the S-MN 310. Alternatively or additionally, the T-MN (e.g., the other T-MN 360 as shown in the FIG. 3C) may also forward 348 the conditional handover failure report to the T-MN 340.

In some embodiments, if the selected cell is the source cell, the UE 320 may perform 342 an access procedure on the source cell transmit 344 the conditional handover failure report to the S-MN 310. The S-MN 310 may forward 348 the conditional handover failure report to the T-MN 340.

Based on the conditional handover failure report, the S-MN 310 may optimize the conditional handover related resource management. For example, the S-MN 310 may update the CHO-only execution condition, update the CPAC-associated CHO execution condition (e.g., CHO execution condition, CPAC execution condition), or update the candidate target cell(s) that will be provided to the T-MN 340.

Based on the conditional handover failure report, the T-MN 340 may optimize the conditional handover related resource management. For example, the T-MN 340 may update the configuration of the CHO-only, or update the CPAC execution condition of the CPAC-associated CHO.

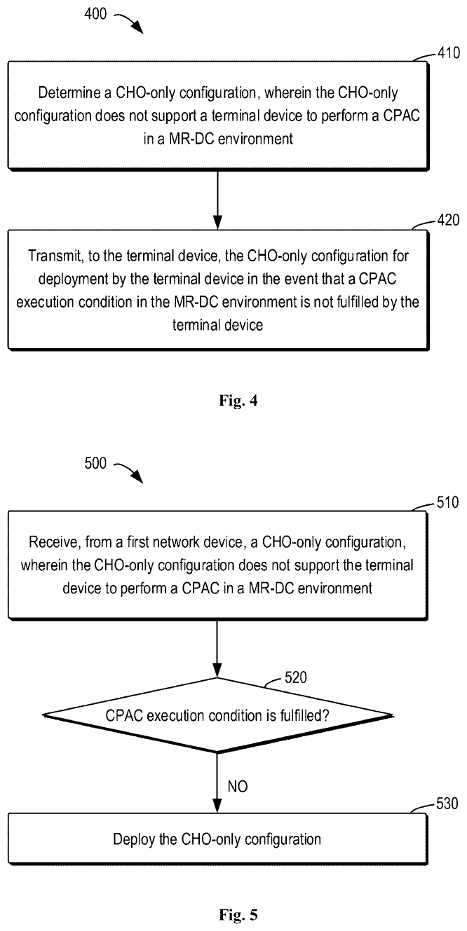

Corresponding to the above processes, embodiments of the present disclosure provide methods of communication implemented at network devices and a terminal device. These methods will be described below with reference to FIGS. 4 to 6.

FIG. 4 illustrates a flowchart of an example method 400 of communication implemented at a first network device in accordance with some embodiments of the present disclosure. For example, the method 400 may be performed at the network device 110 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard.

At block 410, the network device 110 determines a CHO-only configuration, wherein the CHO-only configuration does not support a terminal device (e.g., the terminal device 120 in FIG. 1A) to perform a CPAC in a MR-DC environment. The network device 110 transmits, to the terminal device 120, the CHO-only configuration for deployment by the terminal device 120 in the event that a CPAC execution condition in the MR-DC environment is not fulfilled by the terminal device 120.

In some embodiments, the CHO-only configuration may comprise a cell configuration for at least one candidate target cell associated with a second network device (e.g., the network device 140) and at least one CHO-only execution condition for the at least one candidate target cell. The at least one CHO-only execution condition needs to be fulfilled in order to execute the cell configuration for the at least one candidate target cell associated with the network device 140.

In some embodiments, in order to determine the CHO-only configuration, the network device 110 may send a request for the CHO-only configuration to the network device 140. In response to sending the request, the network device 110 may receive the CHO-only configuration from the network device 140.

In some embodiments, in order to determine the CHO-only configuration, the network device 110 may send a request for the cell configuration for the at least one candidate target cell of CHO-only configuration to the network device 140. In response to sending the request, the network device 110 may receive the cell configuration for the at least one candidate target cell of the CHO-only configuration from the network device 140.

In some embodiments, the network device 110 may determine that the CHO-only configuration is required for the terminal device 120; and transmit, to the network device 140, a first indication that the CHO-only configuration is required for the terminal device 120. In some embodiments, the first indication may be comprised in a handover request message from the network device 110 to the network device 140.

In some embodiments, the network device 110 may receive, from the terminal device 120, a set of measurement results for a set of cells associated with the network device 140 and transmit the set of measurement results to the network device 140. The set of cells may comprise the at least one candidate target cell.

In some embodiments, the network device 110 may transmit, to the terminal device 120, a timer or a time offset for deploying the CHO-only configuration by the terminal device 120.

In some embodiments, the network device 110 may transmit, to the terminal device 120, a second indication to deploy the CHO-only configuration by the terminal device 120. In some embodiments, the second indication may be comprised in RRC signaling between the terminal device 120 and the network device 110.

In some embodiments, the second indication may be comprised in a MAC CE between the terminal device 120 and the network device 110. Prior to transmitting the second indication, the network device 110 may receive, from the terminal device 120, a third indication that a CHO execution condition is fulfilled but the CPAC execution condition is not fulfilled.

In some embodiments, the network device 110 may receive, from the network device 140, a fourth indication that the terminal device 120 has accessed the at least one candidate target cell associated with the CHO-only configuration.

In some embodiments, the network device 110 may receive, from a third network device, a fifth indication that the terminal device 120 has failed access to one of the at least one candidate target cell associated with the CHO-only configuration.

In some embodiments, the CHO-only configuration comprises a set of first configurations associated with a first set of candidate target cells. The network device 110 may transmit, to the terminal device 120, a CPAC-associated CHO configuration. The CPAC-associated CHO configuration may comprise a set of second configurations associated with a second set of candidate target cells.

In some embodiments, the second set of candidate target cells may be identical with the first set of candidate target cells. The network device 110 may transmit, to the terminal device 120, a sixth indication in the case that the terminal device 120 selects a second candidate target cell from among the second set of candidate target cells after a failed access to a first candidate target cell from among the first set of candidate target cells. The sixth indication may indicate deploying the CHO-only configuration. Alternatively, the sixth indication may indicate deploying the CPAC-associated CHO configuration.

In some embodiments, the CHO-only configuration may comprise the sixth indication. Alternatively, the CPAC-associated CHO configuration may comprise the sixth indication. Alternatively, the sixth indication may be neither comprised in the CHO-only configuration nor in the CPAC-associated CHO configuration.

In some embodiments, the network device 110 may receive, from a network device 140, information associated with a first candidate target cell, from among the first set of candidate target cells, that the terminal device 120 has failed access to. Alternatively or additionally, the network device 110 may receive, from a network device 140, information associated with a first candidate target cell, from among the second set of candidate target cells, that the terminal device 120 has failed access to. Alternatively or additionally, the network device 110 may receive, from a network device 140, information associated with a second candidate target cell selected among the set of candidate target cells after the terminal device 120 has failed access to the first candidate target cell. Alternatively or additionally, the network device 110 may receive, from a network device 140, information associated with a second candidate target cell selected among the second set of candidate target cells after the terminal device 120 has failed access to the first candidate target cell. Alternatively or additionally, the network device 110 may receive, from a network device 140, a type of a first configuration deployed by the terminal device 120 for connection with the first candidate target cell. The type of the first configuration may be a CHO-only configuration or a CPAC-associated CHO configuration. Alternatively or additionally, the network device 110 may receive, from a network device 140, a type of a second configuration deployed by the terminal device 120 for connection with the second candidate target cell. The type of the second configuration may be a CHO-only configuration or a CPAC-associated CHO configuration.

In some embodiments, the CPAC-associated CHO configuration may comprise a CHO configuration portion and a CPAC configuration portion. When determining the CHO-only configuration, the network device 110 may receive, from the network device 140, an eighth indication that the CHO-only configuration is identical with the CHO configuration portion.

In some embodiments, one of the set of first configurations may be associated with an identity that is different from an identity associated with one of the set of second configurations. In some embodiments, one of the set of first configurations and one of the set of second configurations may be associated with the same identity.

With the method 400, the communication reliability and efficiency may be improved.

FIG. 5 illustrates a flowchart of an example method 500 of communication implemented at a terminal device in accordance with some embodiments of the present disclosure. For example, the method 500 may be performed at the terminal device 120 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 120 receives, from a first network device (e.g., the network device 110), a CHO-only configuration. The CHO-only configuration does not support the terminal device 120 to perform a CPAC in a MR-DC environment. At block 520, the terminal device 120 determines whether a CPAC execution condition is fulfilled. If not, the process proceeds to bock 530. At block 530, the terminal device 120 deploys the CHO-only configuration.

In some embodiments, the CHO-only configuration may comprise a cell configuration for at least one candidate target cell associated with a second network device (e.g., the network device 140); and at least one CHO-only execution condition for the at least one candidate target cell. The at least one CHO-only execution condition needs to be fulfilled in order to execute the cell configuration for the at least one candidate target cell associated with the network device 140.

In some embodiments, the terminal device 120 may transmit, to the network device 110, a set of measurement results for a set of cells associated with the network device 140. The set of cells may comprise the at least one candidate target cell.

In some embodiments, the terminal device 120 may receive, from the network device 110, a timer for deploying the CHO-only configuration. In some embodiments, the terminal device 120 may start the timer responsive to the CHO execution condition being fulfilled but the CPAC execution condition not being fulfilled; and stop the timer responsive to both the CHO execution condition and the CPAC execution condition being fulfilled. In some embodiments, the terminal device 120 may deploy the CHO-only configuration responsive to expiry of the timer.

In some embodiments, the terminal device 120 may receive, from the network device 110, a time offset for deploying the CHO-only configuration. The terminal device 120 may deploy the CHO-only configuration responsive to a duration of the CHO execution condition being fulfilled but the CPAC execution condition not being fulfilled by the time offset.

In some embodiments, the terminal device 120 may receive, from the network device 110, a first indication to deploy the CHO-only configuration responsive to the CHO execution condition being fulfilled but the CPAC execution condition not being fulfilled. In some embodiments, the first indication is comprised in a radio resource control (RRC) signaling between the terminal device 120 and the network device 110.

In some embodiments, the terminal device 120 may transmit, to the network device 110, a second indication that the CHO execution condition is fulfilled but the CPAC execution condition is not fulfilled; and receive, from the network device 110, a third indication to deploy the CHO-only configuration. In some embodiments, the third indication may be comprised in a MAC CE.

In some embodiments, the terminal device 120 may transmit, to the network device 140, a fourth indication that the terminal device 120 has accessed the at least one candidate target cell associated with the CHO-only configuration. In some embodiments, the terminal device 120 may transmit a fifth indication that the terminal device 120 has failed access to one of the at least one candidate target cell associated with the CHO-only configuration.

In some embodiments, the CHO-only configuration may comprise a set of first configurations associated with a first set of candidate target cells. The terminal device 120 may receive, from the network device 110, a CPAC-associated CHO configuration. The CPAC-associated CHO configuration may comprise a set of second configurations associated with a second set of candidate target cells.

In some embodiments, the terminal device 120 may receive, from the network device 110, a sixth indication of deploying the CHO-only configuration for recovery; select a cell after a failed access to a first candidate target cell from among the first set of candidate target cells; and deploy the CHO-only configuration for connection with the selected cell in the case that the selected cell is from among the first set of candidate target cells. In some embodiments, the CHO-only configuration may comprise the sixth indication. Alternatively, the sixth indication may be not comprised in the CHO-only configuration.

In some embodiments, the terminal device 120 may receive, from the network device 110, a seventh indication of deploying the CPAC-associated CHO configuration for recovery; select a cell after a failed access to a first candidate target cell from among the second set of candidate target cells; and deploy the CPAC-associated CHO configuration for connection with the selected cell in the case that the selected cell is from among the second set of candidate target cells. In some embodiments, the CPAC-associated CHO configuration may comprise the seventh indication. Alternatively, the seventh indication may be not comprised in the CPAC-associated CHO configuration.

In some embodiments, the terminal device 120 may select a cell after a failed access to a first candidate target cell from among the first set of candidate target cells, wherein the selected cell is from among the first set of candidate target cells. or from among the second set of candidate target cells The terminal device 120 may transmit, to a network device associated with the selected cell, information associated with the first candidate target cell that the terminal device 120 has failed access to. Alternatively or additionally, the terminal device 120 may transmit, to a network device associated with the selected cell, information associated with the selected cell. Alternatively or additionally, the terminal device 120 may transmit, to a network device associated with the selected cell, a type of a first configuration deployed by the terminal device 120 for connection with the first candidate target cell. The type of the first configuration may be a CHO-only configuration or a CPAC-associated CHO configuration. Alternatively or additionally, the terminal device 120 may transmit, to a network device associated with the selected cell, a type of a second configuration deployed by the terminal device 120 for connection with the selected cell. The type of the second configuration may be a CHO-only configuration or a CPAC-associated CHO configuration.

In some embodiments, the CPAC-associated CHO configuration may comprise a CHO configuration portion and a CPAC configuration portion. The terminal device 120 may receive, from the network device 110, an eighth indication that the CHO-only configuration is identical with the CHO configuration portion.

In some embodiments, one of the set of first configurations is associated with an identity that is different from an identity associated with one of the set of second configurations. In some embodiments, one of the set of first configurations and one of the set of second configurations are associated with the same identity.

With the method 500, the terminal device may perform CHO even when the CPAC execution condition is not fulfilled. Thus, the communication reliability and efficiency may be improved.

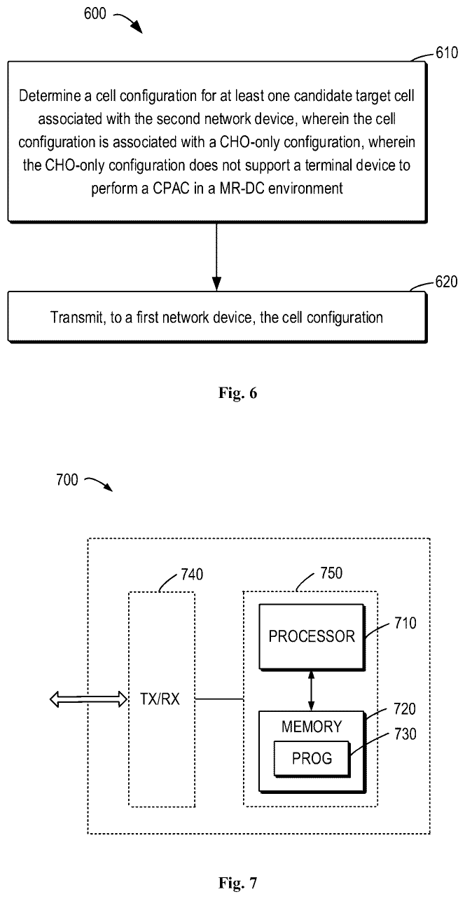

FIG. 6 illustrates a flowchart of an example method 600 of communication implemented at a second network device in accordance with some embodiments of the present disclosure. For example, the method 600 may be performed at the network device 140 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the network device 140 determines a cell configuration for at least one candidate target cell associated with the network device 140. The cell configuration may be associated with a CHO-only configuration. The CHO-only configuration does not support a terminal device 120 to perform a CPAC in a MR-DC environment. At block 620, the network device 140 transmits the cell configuration to a first network device (e.g., the network device 110).

In some embodiments, the network device 140 may determine at least one CHO-only execution condition for the at least one candidate target cell. The at least one CHO-only execution condition needs to be fulfilled in order to execute of the cell configuration for the at least one candidate target cell. The network device 140 may transmit the at least one CHO-only execution condition to the network device 110.

In some embodiments, the network device 140 may receive, from the network device 110, a request for the CHO-only configuration; and transmit the CHO-only configuration to the network device 110.

In some embodiments, the network device 140 may receive, from the network device 110, a first indication that the cell configuration is required for a terminal device 120. In some embodiments, the first indication may be comprised in a handover request message from the network device 110 to the network device 140.

In some embodiments, the network device 140 may receive, from the network device 110, a set of measurement results for a set of cells associated with the network device 140. The set of cells may comprise the at least one candidate target cell. The network device 140 may determine, based on the set of measurement results, that the cell configuration is required for a terminal device 120.

In some embodiments, the network device 140 may receive, from a terminal device (e.g., the terminal device 120), a second indication that the terminal device 120 has accessed the at least one candidate target cell associated with the CHO-only configuration; and transmit the second indication to the network device 110.

In some embodiments, the network device 140 may receive, from a third network device, a third indication that a terminal device 120 has failed access to a first candidate target cell among the at least one candidate target cell.

In some embodiments, the network device 140 may receive, from a terminal device 120, a fourth indication that the terminal device 120 has failed access to a first candidate target cell of a set of candidate target cells comprising the at least one candidate target cell; and transmit the fourth indication to the network device 110.

In some embodiments, the network device 140 may receive, from a terminal device 120, a fifth indication that the terminal device 120 has failed access to a first candidate target cell of a set of candidate target cells comprising the at least one candidate target cell; and transmit the fifth indication to a third network device associated with the first candidate target cell.

In some embodiments, the indication may comprise information associated with the first candidate target cell that the terminal device 120 has failed access to. Alternatively or additionally, the indication may comprise information associated with a second candidate target cell selected from among the set of candidate target cells after the terminal device 120 has failed access to the first candidate target cell. Alternatively or additionally, the indication may comprise a type of a first configuration deployed by the terminal device 120 for connection with the first candidate target cell. The type of the first configuration may be a CHO-only configuration or a CPAC-associated CHO configuration. Alternatively or additionally, the indication may comprise a type of a second configuration deployed by the terminal device 120 for connection with the second candidate target cell. The type of the second configuration may be a CHO-only configuration or a CPAC-associated CHO configuration.

In some embodiments, the network device 140 may transmit, to the network device 110, a sixth indication that the CHO-only configuration is identical with a CHO configuration portion in a CPAC-associated CHO configuration.

With the method 600, a CHO-only configuration may be provided to complement the legacy CPAC-associated CHO configuration.

It is to be understood that operations of the methods 400 to 600 correspond to that described in connection with FIGS. 2 to 3C, and thus other details are not repeated here for concise.

FIG. 7 is a simplified block diagram of a device 700 that is suitable for implementing embodiments of the present disclosure. The device 700 can be considered as a further example implementation of the terminal device 120 or the network device 110 or 140 as shown in FIG. 1A. Accordingly, the device 700 can be implemented at or as at least a part of the terminal device 120 or the network device 110 or 140.

As shown, the device 700 includes a processor 710, a memory 720 coupled to the processor 710, a suitable transmitter (TX) and receiver (RX) (e.g., a transceiver) 740 coupled to the processor 710, and a communication interface coupled to the TX/RX 740. The memory 710 stores at least a part of a program 1130. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In summary, embodiments of the present disclosure may provide the following solutions.
Clause 1. A first network device comprising: a processor; and a transceiver coupled to the processor, wherein the processor is configured to: determine a conditional handover (CHO)-only configuration, wherein the CHO-only configuration does not support a terminal device to perform a conditional primary secondary cell addition or change (CPAC) in a multi-radio dual connectivity (MR-DC) environment; and transmit, via the transceiver to the terminal device, the CHO-only configuration for deployment by the terminal device in the event that a CPAC execution condition in the MR-DC environment is not fulfilled by the terminal device.
Clause 2. The first network device of clause 1, wherein the CHO-only configuration comprises: a cell configuration for at least one candidate target cell associated with a second network device; and at least one CHO-only execution condition for the at least one candidate target cell, wherein the at least one CHO-only execution condition needs to be fulfilled in order to execute the cell configuration for the at least one candidate target cell associated with the second network device.
Clause 3. The first network device of clause 1, wherein the processor is configured to determine the CHO-only configuration by: sending, via the transceiver to a second network device, a request for the CHO-only configuration; and in response to sending the request, receiving the CHO-only configuration from the second network device via the transceiver.
Clause 4. The first network device of clause 1, wherein the processor is configured to determine the CHO-only configuration by: sending, via the transceiver to a second network device, a request for the cell configuration for the at least one candidate target cell of CHO-only configuration; and in response to sending the request, receiving the cell configuration for the at least one candidate target cell of the CHO-only configuration from the second network device via the transceiver.
Clause 5. The first network device of clause 1, wherein the processor is further configured to: determine that the CHO-only configuration is required for the terminal device; and transmit, via the transceiver to a second network device, a first indication that the CHO-only configuration is required for the terminal device.
Clause 6. The first network device of clause 5, wherein the first indication is comprised in a handover request message from the first network device to the second network device.
Clause 7. The first network device of clause 1, wherein the processor is further configured to: receive, via the transceiver from the terminal device, a set of measurement results for a set of cells associated with the second network device, wherein the set of cells comprise the at least one candidate target cell; and transmit, via the transceiver to the second network device, the set of measurement results.
Clause 8. The first network device of clause 1, wherein the processor is further configured to: transmit, via the transceiver to the terminal device, a timer or a time offset for deploying the CHO-only configuration by the terminal device.
Clause 9. The first network device of clause 1, wherein the processor is further configured to: transmit, via the transceiver to the terminal device, a second indication to deploy the CHO-only configuration by the terminal device.
Clause 10. The first network device of clause 9, wherein the second indication is comprised in radio resource control (RRC) signaling between the terminal device and the first network device.
Clause 11. The first network device of clause 9, wherein the second indication is comprised in a medium access control (MAC) control element (CE) between the terminal device and the first network device, and the processor is further configured to: prior to transmitting the second indication, receive, via the transceiver from the terminal device, a third indication that the CPAC execution condition is not fulfilled.
Clause 12. The first network device of clause 2, wherein the processor is further configured to: receive, via the transceiver from the second network device, a fourth indication that the terminal device has accessed the at least one candidate target cell associated with the CHO-only configuration.
Clause 13. The first network device of clause 2, wherein the processor is further configured to: receive, via the transceiver from a third network device, a fifth indication that the terminal device has failed access to one of the at least one candidate target cell associated with the CHO-only configuration.
Clause 14. The first network device of clause 1, wherein the CHO-only configuration comprises a set of first configurations associated with a first set of candidate target cells, and the processor is further configured to: transmit, via the transceiver to the terminal device, a CPAC-associated CHO configuration, wherein the CPAC-associated CHO configuration comprises a set of second configurations associated with a second set of candidate target cells.
Clause 15. The first network device of clause 14, wherein the second set of candidate target cells is identical with the first set of candidate target cells, and the processor is further configured to: transmit, via the transceiver to the terminal device, a sixth indication in the case that the terminal device selects a second candidate target cell from among the second set of candidate target cells after a failed access to a first candidate target cell from among the first set of candidate target cells, wherein the sixth indication: indicates deploying the CHO-only configuration; or indicates deploying the CPAC-associated CHO configuration.
Clause 16. The first network device of clause 15, wherein one of the following: the CHO-only configuration comprises the sixth indication; the CPAC-associated CHO configuration comprises the sixth indication; or the sixth indication is neither comprised in the CHO-only configuration nor in the CPAC-associated CHO configuration.
Clause 17. The first network device of clause 14, wherein the processor is further configured to receive, via the transceiver from a second network device, one of the following: information associated with a first candidate target cell, from among the first set of candidate target cells, that the terminal device has failed access to; information associated with a first candidate target cell, from among the second set of candidate target cells, that the terminal device has failed access to; information associated with a second candidate target cell selected among the first set of candidate target cells after the terminal device has failed access to the first candidate target cell; information associated with a second candidate target cell selected among the second set of candidate target cells after the terminal device has failed access to the first candidate target cell; a type of a first configuration deployed by the terminal device for connection with the first candidate target cell, wherein the type of the first configuration is a CHO-only configuration or a CPAC-associated CHO configuration; or a type of a second configuration deployed by the terminal device for connection with the second candidate target cell, wherein the type of the second configuration is a CHO-only configuration or a CPAC-associated CHO configuration.
Clause 18. The first network device of clause 14, wherein the CPAC-associated CHO configuration comprises a CHO configuration portion and a CPAC configuration portion, and the processor is configured to determine the CHO-only configuration by: receiving, via the transceiver from a second network device, an eighth indication that the CHO-only configuration is identical with the CHO configuration portion.
Clause 19. The first network device of clause 14, wherein one of the set of first configurations is associated with an identity that is different from an identity associated with one of the set of second configurations.
Clause 20. The first network device of clause 14, wherein: one of the set of first configurations and one of the set of second configurations are associated with the same identity.
Clause 21. A terminal device comprising: a processor; and a transceiver coupled to the processor, wherein the processor is configured to: receive, via the transceiver from a first network device, a conditional handover (CHO)-only configuration, wherein the CHO-only configuration does not support the terminal device to perform a conditional primary secondary cell addition or change (CPAC) in a multi-radio dual connectivity (MR-DC) environment; and deploy the CHO-only configuration in the event that a CPAC execution condition is not fulfilled.
Clause 22. The terminal device of clause 21, wherein the CHO-only configuration comprises: a cell configuration for at least one candidate target cell associated with a second network device; and at least one CHO-only execution condition for the at least one candidate target cell, wherein the at least one CHO-only execution condition needs to be fulfilled in order to execute the cell configuration for the at least one candidate target cell associated with the second network device.
Clause 23. The terminal device of clause 22, wherein the processor is further configured to: transmit, via the transceiver to the first network device, a set of measurement results for a set of cells associated with the second network device, wherein the set of cells comprises the at least one candidate target cell.
Clause 24. The terminal device of clause 21, wherein the processor is further configured to: receive, via the transceiver from the first network device, a timer for deploying the CHO-only configuration.
Clause 25. The terminal device of clause 24, wherein the processor is further configured to: start the timer responsive to a CHO execution condition being fulfilled but the CPAC execution condition not being fulfilled; and stop the timer responsive to both the CHO execution condition and the CPAC execution condition being fulfilled.
Clause 26. The terminal device of clause 24 or 25, wherein the processor is configured to deploy the CHO-only configuration responsive to expiry of the timer.
Clause 27. The terminal device of clause 21, wherein the processor is further configured to: receive, via the transceiver from the first network device, a time offset for deploying the CHO-only configuration; and the processor is configured to deploy the CHO-only configuration responsive to a duration of the CHO execution condition being fulfilled but the CPAC execution condition not being fulfilled by the time offset.
Clause 28. The terminal device of clause 21, wherein the processor is further configured to: receive, via the transceiver from the first network device, a first indication to deploy the CHO-only configuration responsive to the CPAC execution condition not being fulfilled.
Clause 29. The terminal device of clause 28, wherein the first indication is comprised in a radio resource control (RRC) signaling between the terminal device and the first network device.
Clause 30. The terminal device of clause 21, wherein the processor is further configured to: transmit, via the transceiver to the first network device, a second indication that the CPAC execution condition is not fulfilled; and receive, via the transceiver from the first network device, a third indication to deploy the CHO-only configuration.
Clause 31. The terminal device of clause 30, wherein the third indication is comprised in a medium access control (MAC) control element (CE) between the terminal device and the first network device.
Clause 32. The terminal device of clause 22, wherein the processor is further configured to: transmit, via the transceiver to the second network device, a fourth indication that the terminal device has accessed the at least one candidate target cell associated with the CHO-only configuration.
Clause 33. The terminal device of clause 22, wherein the processor is further configured to: transmit, via the transceiver, a fifth indication that the terminal device has failed access to one of the at least one candidate target cell associated with the CHO-only configuration.
Clause 34. The terminal device of clause 21, wherein the CHO-only configuration comprises a set of first configurations associated with a first set of candidate target cells, and the processor is further configured to: receive, via the transceiver from the first network device, a CPAC-associated CHO configuration, wherein the CPAC-associated CHO configuration comprises a set of second configurations associated with a second set of candidate target cells.
Clause 35. The terminal device of clause 34, wherein the processor is further configured to: receive, via the transceiver from the first network device, a sixth indication of deploying the CHO-only configuration for recovery; select a cell after a failed access to a first candidate target cell from among the first set of candidate target cells; and deploy the CHO-only configuration for connection with the selected cell in the case that the selected cell is from among the first set of candidate target cells.
Clause 36. The terminal device of clause 34, wherein the processor is further configured to: receive, via the transceiver from the first network device, a seventh indication of deploying the CPAC-associated CHO configuration for recovery; select a cell after a failed access to a first candidate target cell from among the second set of candidate target cells; and deploy the CPAC-associated CHO configuration for connection with the selected cell in the case that the selected cell is from among the second set of candidate target cells.
Clause 37. The terminal device of clause 35, wherein one of the following: the CHO-only configuration comprises the sixth indication; or the sixth indication is not comprised in the CHO-only configuration.
Clause 38. The terminal device of clause 36, wherein one of the following: the CPAC-associated CHO configuration comprises the seventh indication; or the seventh indication is not comprised in the CPAC-associated CHO configuration.
Clause 39. The terminal device of clause 34, wherein the processor is further configured to: select a cell after a failed access to a first candidate target cell from among the first set of candidate target cells, wherein the selected cell is from among the first set of candidate target cells or from among the second set of candidate target cells; and transmit, via the transceiver to a second network device associated with the selected cell, one of the following: information associated with the first candidate target cell that the terminal device has failed access to; information associated with the selected cell; a type of a first configuration deployed by the terminal device for connection with the first candidate target cell, wherein the type of the first configuration is a CHO-only configuration or a CPAC-associated CHO configuration; or a type of a second configuration deployed by the terminal device for connection with the selected cell, wherein the type of the second configuration is a CHO-only configuration or a CPAC-associated CHO configuration.
Clause 40. The terminal device of clause 34, wherein the CPAC-associated CHO configuration comprises a CHO configuration portion and a CPAC configuration portion, and the processor is further configured to: receive, via the transceiver from the first network device, an eighth indication that the CHO-only configuration is identical with the CHO configuration portion.
Clause 41. The terminal device of clause 34, wherein one of the set of first configurations is associated with an identity that is different from an identity associated with one of the set of second configurations.
Clause 42. The terminal device of clause 34, wherein: one of the set of first configurations and one of the set of second configurations are associated with the same identity.
Clause 43. A second network device comprising: a processor; and a transceiver coupled to the processor, wherein the processor is configured to: determine a cell configuration for at least one candidate target cell associated with the second network device, wherein the cell configuration is associated with a conditional handover (CHO)-only configuration that does not support a terminal device to perform a conditional primary secondary cell addition or change (CPAC) in a multi-radio dual connectivity (MR-DC) environment; and transmit, via the transceiver, the cell configuration to a first network device.
Clause 44. The second network device of clause 43, wherein the processor is configured to: determine at least one CHO-only execution condition for the at least one candidate target cell, wherein the at least one CHO-only execution condition needs to be fulfilled in order to execute of the cell configuration for the at least one candidate target cell; and transmit, via the transceiver to the first network device, the at least one CHO-only execution condition.
Clause 45. The second network device of clause 43, wherein the processor is further configured to: receive, via the transceiver from the first network device, a request for the CHO-only configuration; and transmit the CHO-only configuration to the first network device via the transceiver.
Clause 46. The second network device of clause 43, wherein the processor is further configured to: receive, via the transceiver from the first network device, a first indication that the cell configuration is required for a terminal device.
Clause 47. The second network device of clause 46, wherein the first indication is comprised in a handover request message from the first network device to the second network device.
Clause 48. The second network device of clause 43, wherein the processor is further configured to: receive, via the transceiver from the first network device, a set of measurement results for a set of cells associated with the second network device, wherein the set of cells comprises the at least one candidate target cell; and determine, based on the set of measurement results, that the cell configuration is required for a terminal device.
Clause 49. The second network device of clause 43, wherein the processor is further configured to: receive, via the transceiver from a terminal device, a second indication that the terminal device has accessed the at least one candidate target cell associated with the CHO-only configuration; and transmit, via the transceiver to the first network device, the second indication.
Clause 50. The second network device of clause 43, wherein the processor is further configured to: receive, via the transceiver from a third network device, a third indication that a terminal device has failed access to a first candidate target cell among the at least one candidate target cell.
Clause 51. The second network device of clause 43, wherein the processor is further configured to: receive, via the transceiver from a terminal device, a fourth indication that the terminal device has failed access to a first candidate target cell of a set of candidate target cells comprising the at least one candidate target cell; and transmit, via the transceiver to the first network device, the fourth indication.
Clause 52. The second network device of clause 43, wherein the processor is further configured to: receive, via the transceiver from a terminal device, a fifth indication that the terminal device has failed access to a first candidate target cell of a set of candidate target cells comprising the at least one candidate target cell; and transmit, via the transceiver to a third network device associated with the first candidate target cell, the fifth indication.
Clause 53. The second network device of any one of clauses 50-52, wherein the indication comprises one of the following: information associated with the first candidate target cell that the terminal device has failed access to; information associated with a second candidate target cell selected from among the set of candidate target cells after the terminal device has failed access to the first candidate target cell; a type of a first configuration deployed by the terminal device for connection with the first candidate target cell, wherein the type of the first configuration is a CHO-only configuration or a CPAC-associated CHO configuration; or a type of a second configuration deployed by the terminal device for connection with the second candidate target cell, wherein the type of the second configuration is a CHO-only configuration or a CPAC-associated CHO configuration.
Clause 54. The second network device of clause 43, wherein the processor is further configured to: transmit, via the transceiver to the first network device, a sixth indication that the CHO-only configuration is identical with a CHO configuration portion in a CPAC-associated CHO configuration.
Clause 55. A method performed by a first network device, comprising: determining a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to the terminal device, the CHO-only configuration for deployment by the terminal device in the event that a CPAC execution condition in the MR-DC environment is not fulfilled by the terminal device.
Clause 56. A method performed by a terminal device, comprising: receiving, from a first network device, a conditional handover (CHO)-only configuration, wherein the CHO-only configuration does not support the terminal device to perform a conditional primary secondary cell addition or change (CPAC) in a multi-radio dual connectivity (MR-DC) environment; and deploying the CHO-only configuration in the event that a CPAC execution condition is not fulfilled.
Clause 57. A method performed by a second network device, comprising: determining a cell configuration for at least one candidate target cell associated with the second network device, wherein the cell configuration is associated with a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to a first network device, the cell configuration.
Clause 58. A non-transitory computer readable medium having program instructions stored thereon that, when executed by an apparatus, cause the apparatus at least to: determining a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to the terminal device, the CHO-only configuration for deployment by the terminal device in the event that a CPAC execution condition in the MR-DC environment is not fulfilled by the terminal device.
Clause 59. A non-transitory computer readable medium having program instructions stored thereon that, when executed by an apparatus, cause the apparatus at least to: receiving, from a first network device, a conditional handover (CHO)-only configuration, wherein the CHO-only configuration does not support the apparatus to perform a conditional primary secondary cell addition or change (CPAC) in a multi-radio dual connectivity (MR-DC) environment; and deploying the CHO-only configuration in the event that a CPAC execution condition is not fulfilled.
Clause 60. A non-transitory computer readable medium having program instructions stored thereon that, when executed by an apparatus, cause the apparatus at least to: determining a cell configuration for at least one candidate target cell associated with the apparatus, wherein the cell configuration is associated with a conditional handover (CHO)-only configuration, wherein the CHO-only configuration does not support a terminal device to perform a conditional primary secondary cell addition or change (CPAC) in a multi-radio dual connectivity (MR-DC) environment; and transmitting, to a first network device, the cell configuration.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first network device for wireless communication, comprising:
at least one memory; and
at least one processor coupled with the at least one memory and operable to cause the first network device to:
determine a conditional handover (CHO)-only configuration, wherein the CHO-only configuration does not support a user equipment (UE) to perform a conditional primary secondary cell addition or change (CPAC) in a multi-radio dual connectivity (MR-DC) environment; and
transmit the CHO-only configuration for deployment by the UE in an event that a CPAC execution condition in the MR-DC environment is not fulfilled by the UE.

2. The first network device of claim 1, wherein the at least one processor is operable to cause the first network device to determine the CHO-only configuration by:
sending a request for the cell configuration for at least one candidate target cell of the CHO-only configuration; and
receiving, in response to sending the request, the cell configuration for the at least one candidate target cell of the CHO-only configuration.

3. The first network device of claim 1, wherein the at least one processor is further operable to cause the first network device to:
receive a first indication that the UE has accessed at least one candidate target cell associated with the CHO-only configuration.

4. The first network device of claim 1, wherein the at least one processor is further operable to cause the first network device to receive at least one of:
information associated with a first candidate target cell, from among a first set of candidate target cells, that the UE has failed to access;
information associated with a first candidate target cell, from among a second set of candidate target cells, that the UE has failed to access;
information associated with a second candidate target cell selected among the first set of candidate target cells after the UE has failed to access the first candidate target cell;
information associated with a second candidate target cell selected among the second set of candidate target cells after the UE has failed to access the first candidate target cell;
a type of a first configuration deployed by the UE for connection with the first candidate target cell, wherein the type of the first configuration is a CHO-only configuration or a CPAC-associated CHO configuration; or
a type of a second configuration deployed by the UE for connection with the second candidate target cell, wherein the type of the second configuration is a CHO-only configuration or a CPAC-associated CHO configuration.

5. The first network device of claim 1, wherein a CPAC-associated CHO configuration comprises a CHO configuration portion and a CPAC configuration portion, and wherein the at least one processor is operable to cause the first network device to determine the CHO-only configuration by:
receiving a second indication that the CHO-only configuration is identical with the CHO configuration portion.

6. A user equipment (UE) for wireless communication, comprising:
at least one memory; and
at least one processor coupled with the at least one memory and operable to cause the UE to:
receive a conditional handover (CHO)-only configuration, wherein the CHO-only configuration does not support the UE to perform a conditional primary secondary cell addition or change (CPAC) in a multi-radio dual connectivity (MR-DC) environment; and
deploy the CHO-only configuration in an event that a CPAC execution condition is not fulfilled.

7. The UE of claim 6, wherein the at least one processor is further operable to cause the UE to:
receive a time offset for deploying the CHO-only configuration; and
deploy the CHO-only configuration responsive to a duration of a CHO execution condition being fulfilled and the CPAC execution condition not being fulfilled by the time offset.

8. The UE of claim 6, wherein the at least one processor is further operable to cause the UE to:
receive a first indication to deploy the CHO-only configuration responsive to the CPAC execution condition not being fulfilled.

9. The UE of claim 6, wherein the at least one processor is further operable to cause the UE to:
transmit a second indication that the UE has accessed one of at least one candidate target cell associated with the CHO-only configuration.

10. The UE of claim 6, wherein the at least one processor is further operable to cause the UE to:
receive a fourth indication of deploying the CHO-only configuration for recovery;
select a cell after a failed access to a first candidate target cell from among a first set of candidate target cells; and
deploy the CHO-only configuration for connection with the selected cell in a case that the selected cell is from among the first set of candidate target cells.

11. The UE of claim 6, wherein the at least one processor is further operable to cause the UE to:
receive a fifth indication of deploying a CPAC-associated CHO configuration for recovery;
select a cell after a failed access to a first candidate target cell from among a second set of candidate target cells; and
deploy the CPAC-associated CHO configuration for connection with the selected cell in a case that the selected cell is from among the second set of candidate target cells.

12. The UE of claim 6, wherein the at least one processor is further operable to cause the UE to:
select a cell after a failed access to a first candidate target cell from among a first set of candidate target cells, wherein the selected cell is from among the first set of candidate target cells; and
transmit information associated with the selected cell.

13. The UE of claim 6, wherein a CPAC-associated CHO configuration comprises a CHO configuration portion and a CPAC configuration portion, and the at least one processor is further operable to cause the UE to:
receive a sixth indication that the CHO-only configuration is identical with the CHO configuration portion.

14. (canceled)

15. A second network device for wireless communication, comprising:
at least one memory; and
at least one processor coupled with the at least one memory and operable to cause the second network device to:
determine a cell configuration for at least one candidate target cell associated with the second network device, wherein the cell configuration is associated with a conditional handover (CHO)-only configuration that does not support a user equipment (UE) to perform a conditional primary secondary cell addition or change (CPAC) in a multi-radio dual connectivity (MR-DC) environment; and
transmit the cell configuration to a first network device.

16. The second network device of claim 15, wherein the at least one processor is further operable to cause the second network device to:
transmit a first indication that the UE has accessed at least one candidate target cell associated with the CHO-only configuration.

17. A method performed by a user equipment (UE), the method comprising:
receiving a conditional handover (CHO)-only configuration, wherein the CHO-only configuration does not support the UE to perform a conditional primary secondary cell addition or change (CPAC) in a multi-radio dual connectivity (MR-DC) environment; and
deploying the CHO-only configuration in an event that a CPAC execution condition is not fulfilled.

18. The method of claim 17, further comprising:
receiving a first indication to deploy the CHO-only configuration responsive to the CPAC execution condition not being fulfilled.

19. The method of claim 17, further comprising:
selecting a cell after a failed access to a first candidate target cell from among a first set of candidate target cells, wherein the selected cell is from among the first set of candidate target cells; and
sending information associated with the selected cell.

20. The method of claim 17, further comprising:
receiving a time offset for deploying the CHO-only configuration; and
deploying the CHO-only configuration responsive to a duration of a CHO execution condition being fulfilled and the CPAC execution condition not being fulfilled by the time offset.

21. The method of claim 17, further comprising:
receiving a first indication to deploy the CHO-only configuration responsive to the CPAC execution condition not being fulfilled.
